(19) United States
(12) Patent Application Publication
(10) Pub. No.: US 2006/0208996 A1
(43) Pub. Date: Sep. 21, 2006

(54) Semiconductor circuit

(75) Inventors: Toshikazu Tachibana, Kodaira (JP); Yoshitaka Iwasaki, Kodaira (JP); Kazuya Endo, Hachioji (JP); Goro Sakamaki, Fuchu (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/337,583

(22) Filed: Jan. 24, 2006

(30) Foreign Application Priority Data
Jan. 26, 2005 (JP) 2005-017727

(51) Int. Cl. G09G 3/36

(52) U.S. Cl. 345/100

(57) ABSTRACT

A two-stage decode system is provided which uses a pre-stage decoder comprising a pre-stage first decoder which decodes a bit of arbitrary part of address signals and a pre-stage second decoder which decodes the remaining bits, level shifters which respectively shift the levels of outputs of the pre-stage decoder, and post-stage decoders which respectively decode the decode outputs of the respective decoders in the pre-stage decoder, which have been level-shifted by the level shifters.

### CROSS-REFERENCE TO RELATED APPLICATION

The present application claims priority from Japanese patent application No. 2005-017727 filed on Jan. 26, 2005, the content of which is hereby incorporated by reference into this application.

### BACKGROUND OF THE INVENTION

The present invention relates to a semiconductor circuit, and particularly to a semiconductor circuit which constitutes a drive circuit for driving pixels of an active panel type display unit using a liquid crystal panel or an organic electroluminescent panel or the like.

An STN type display unit in which wirings are strung at a display section in two directions of an X-axis direction (first direction) and a Y-axis direction (direction different from the first direction) and liquid crystals at intersecting points are driven when voltages are applied thereto from the two directions of X and Y, and an active/matrix type display unit, which has active elements such as thin film transistors (TFTs) every pixels and switching-drives the active elements, are known as panel type display units such as a liquid crystal display unit, an organic electroluminescent (organic EL) display unit, etc. The present invention is characterized by a circuit configuration of a semiconductor circuit corresponding to a drive circuit for effecting a display on a display panel applied to this type of panel type display unit, and a circuit layout of a semiconductor integrated circuit chip in which this circuit is integrated.

For example, an active/matrix type liquid crystal display unit using thin film transistors as active elements has a liquid crystal layer sealed between a pair of insulated boards for which a glass plate is suitable, and is formed with a large number of pixels disposed in its display area in matrix form. A semiconductor integrated circuit chip corresponding to a drive circuit is mounted in a portion other than display area. The thin film transistors that constitute the respective pixels are led out outside the display area through lead lines and connected to the semiconductor integrated circuit chip. The thin film transistors disposed in the display area are connected to 256 output terminals of gate drivers constituting the semiconductor integrated circuit chip by, for example, 256 gate lines in a scan direction. The thin film transistors are selected based on gate signals outputted from the output terminals and display data are supplied to the source lines of the selected thin film transistors connected to the gate lines to perform a display thereof.

Since such an active/matrix type liquid crystal display unit applies liquid crystal drive voltages (gradation voltages) to respective pixel electrodes of red (RR), green (G) and blue (B) through the thin film transistors, no crosstalk occurs between the pixels and a crosstalk-free multigradation display is enabled.

FIG. 25 is a block diagram for describing a configurational example of a gate driver section previously considered by the inventors of the present application. FIG. 26 is a fragmentary operation waveform diagram of FIG. 25. In this configuration, address signals for selecting gate lines G1, G2, G3, G4, . . . G256 are 8 bits. The address signals [0] through [7] of the 8 bits are counted up by an unillustrated address counter and inputted. The inputted address signals [0] through [7] are decoded by a decode circuit or decoder DCR ((A000) through (A255)) and respectively latched in latches LTs in response to a latch clock. The decode outputs latched in the latches LTs are inputted to a high breakdown section through NOR gates NRs. A voltage level range of the latched decode outputs ranges from 3V through 0V, for example. Incidentally, shift registers may be used as an alternative to the latches.

The high breakdown section comprises level shifters LSs and a plurality of high breakdown inverters HVs (three in the present example). Their output terminals (gate line terminals) GTMs are connected to their corresponding gate lines of a display panel to supply gate signals G1 through G256. The level shifters LSs respectively shift the inputted signals of 3V to 0V to high voltage levels of 16V to −14V. Gate drivers GDRs each comprising the level shifter LS and three high breakdown inverters HVs are placed in their corresponding gate lines G1, G2, G3, G4, . . . . G256. Incidentally, the NOR gates NRs are respectively gates which turn on/off displays to the display panel. They are used to discharge electrical charges of pixel portions in the display section upon non-display at the time that an all select signal is inputted.

The address signals [0] through [7] are inputted as shown in FIG. 26 and latched in their corresponding latches LTs with timing in which a latch clock is high in level. The latched address signals are level-shifted at the high breakdown section and respectively supplied from the gate line terminals GTMs to their corresponding gate lines as gate signals G1, G2, G3, . . . .

FIG. 27 is a diagram for describing a configurational example of the level shifter LS shown in FIG. 25, and FIG. 28 is a diagram for describing a specific circuit example of the level shifter LS shown in FIG. 25. Respective voltage values in FIGS. 27 and 28 are as follows: VCC=3V, GND=0V, DDVDH=5V, VGH=15V, and VGL=−10V. The level shifter LS comprises a series circuit of three high breakdown inverters HVs, a normal inverter V parallel-connected to the series circuit, and a series circuit of three high breakdown inverters HVs. Its input corresponds to the output of each latch LT.

As shown in FIG. 27, an output voltage range of the inverter V ranges from VCC to GND, an output voltage range of a first-stage level shifter LSa that constitutes the level shifter LS ranges from DDVDH to GND, an output voltage range of a next-stage level shifter LSb ranges from DDVDH to VGL, and an output voltage range of a final-stage level shifter LSc ranges from VGH to VGL.

The first-stage level shifter LSa comprises four PMOS transistors and two NMOS transistors as shown in the figure. The next-stage level shifter LSb comprises two PMOS transistors and four NMOS transistors as shown in the figure. The final-stage level shifter LSc comprises two PMOS transistors and two NMOS transistors as shown in the figure. The next-stage level shifter LSb and the final-stage level shifter LSc are connected to each other by two inverters.

FIG. 29 is an explanatory diagram of a configurational example of the latch shown in FIG. 25. The latch comprises six inverters V and one NAND gate ND as shown in the figure and latches the output of the decoder DCR in accordance with a latch clock.

FIG. 30 is a diagram for describing a configurational example of the decoder of 8 bits shown in FIG. 25. The decoder comprises inverters V and NAND gates NDs respectively inputted with the address signals AD[0] through AD[7] of 8 bits and NOR gates NRs, and outputs 256 decode outputs (A000) through (A255).

FIG. 31 is a circuit diagram for describing one example of a gateless driver previously considered by the inventors of the present application. The gateless driver GLDR is used together with a display panel GIPNL with gates built therein. The display panel GIPNL has gate drivers built onto a substrate constituting the display panel by thin film transistors each formed of a high current mobility semiconductor film such as low-temperature polysilicon or the like. The gate drivers are constituted of shift registers SRs, high breakdown NOR gates HNRs and high breakdown inverters HVs every gate lines.

The gateless driver GLDR comprises level shifters LSs which level-shift an all select signal, a frame head pulse and a shift register clock ranging from, for example, 3V to 0V, which are inputted from outside, to large-amplitude signals ranging from, for example, 16V to −14V, respectively. The level-shifted respective signals are outputted to their corresponding lead-out terminals GTMs of the display panel GIPNL.

FIG. 32 is a diagram for describing a circuit example of the shift register shown in FIG. 31, and FIG. 33 is a waveform diagram for describing the operation of FIG. 32. The shift register comprises six high breakdown inverters HVs, two high breakdown NOR gates HNRs and a high breakdown AND gate HND as shown in the figure. A frame head pulse level-shifted by the corresponding level shifter LS is inputted to an input terminal INPUT and shifted by a shift register clock level-shifted by the level shifter LS in like manner. Output terminals or outputs OUTPUTs are applied to their corresponding gate lines via the high breakdown NOR gates HNRs and the high breakdown inverters HVs as gate signals G1, G2, G3, G4, . . . G256.

Incidentally, for example, a patent document 1 (Japanese Unexamined Patent Publication No. Hei 8(1996)-106272) can be cited as one in which this type of related art has been disclosed.

### SUMMARY OF THE INVENTION

According to the gate-driver's configurations, the gate drivers GDRs respectively constituted of the level shifters LSs and the three high breakdown inverters HIVs are respectively disposed with respect to the gate lines G1, G2, G3, G4, . . . . G256 in the high breakdown section. As described in FIGS. 28 and 31, each level shifter LS comprises a large number of MOS transistors, and is complex in circuitry and large in circuit scale. Further, its gate line width and gate length are also large and large in exclusively-possessed area. Therefore, there is a limit to a size reduction where such level shifters are integrated into a semiconductor chip. This results in one problem to be solved.

The present invention is to provide a semiconductor circuit which solves the problem in the background art and reduces its circuit scale, and a semiconductor integrated circuit chip in which the semiconductor circuit is brought into integration to enable its size reduction.

The present invention is characterized in that a two-stage decode system using a pre-stage decoder comprising a pre-stage first decoder which decodes a bit of arbitrary part of address signals, and post-stage decoders which respectively decode decode outputs of the respective decoders in the pre-stage decoder, is adopted to solve the problem.

A semiconductor circuit of the present invention relates to gate drivers for supplying gate signals to gate terminals of a display panel in which a large number of pixels constituted of active elements having the gate terminals are arranged in matrix form, and is characterized by using the following means.

[Means 1 for Realizing the Semiconductor Circuit of the Present Invention]

The means 1 comprises,

a pre-stage decoder comprising a pre-stage first decoder which decodes a bit of part of address signals for selecting the gate terminals, and a pre-stage second decoder which decodes the remaining bits of the address signals,

latches which latch decode outputs of the pre-stage first decoder and the pre-stage second decoder respectively,

level shifters which respectively shift respective voltage levels of the decode outputs of the pre-stage first decoder and the pre-stage second decoder, which have been latched in the latches, to a high breakdown side, and

post-stage decoders which decode the outputs of the level shifters respectively.

[Means 2 for Realizing the Semiconductor Circuit of the Present Invention]

The means 2 comprises,

latches each comprising a first latch which latches a bit of part of address signals for selecting the gate terminals and a second latch which latches the remaining bits,

a pre-stage decoder comprising a pre-stage first decoder which decodes the bit of the part latched in the first latch and a pre-stage second decoder which decodes the remaining bits latched in the second latch,

level shifters which respectively shift respective voltage levels of the outputs of the pre-stage first decoder and the pre-stage second decoder to the high breakdown side, and

post-stage decoders which respectively decode the output of the pre-stage first decoder and the output of the pre-stage second decoder both passed through the level shifters.

[Means 3 for Realizing the Semiconductor Circuit of the Present Invention]

The means 3 comprises,

latches each comprising a first latch which latches a bit of part of the address signals for selecting the gate terminals respectively, and a second latch which latches the remaining bits,

level shifters which respectively shift respective voltage levels of the bit of the part and the remaining bits both latched in the first latch and the second latch, to the high breakdown side,

a pre-stage decoder comprising a pre-stage first decoder which decodes the output of the first latch passed through the corresponding level shifter, and a pre-stage second decoder which decodes the output of the second latch passed therethrough, and

post-stage decoders which respectively decode the decode outputs of the pre-stage first decoder and the pre-stage second decoder.

[Means 4 for Realizing the Semiconductor Circuit of the Present Invention]

The means 4 comprises,

latches each comprising a first latch which latches a bit of part of the address signals for selecting the gate terminals respectively, and a second latch which latches the remaining bits,

level shifters which respectively shift respective voltage levels of the bit of the part and the remaining bits both latched in the first latch and the second latch, to the high breakdown side,

a pre-stage decoder comprising a pre-stage first decoder which decodes the output of the first latch passed through the corresponding level shifter, and a pre-stage second decoder which decodes the output of the second latch passed therethrough, and

post-stage decoders which respectively decode the decode outputs of the pre-stage first decoder and the pre-stage second decoder,

wherein the post-stage decoders are buffer decoders which share buffers provided between the post-stage decoders and the gate terminals.

Incidentally, waveforms outputted to the gate terminals in the above means 1 to 3 change between a first reference voltage and a second reference voltage lower in level than the first reference voltage and have inflexion points between the first reference voltage and the second reference voltage when such a change takes place.

A semiconductor integrated circuit chip of the present invention supplies gate signals to gate terminals, respectively, of a display panel in which a number of pixels constituted of active elements having the gate terminals and source terminals are arranged in matrix form, and supplies display data to the source terminals, and is characterized by adopting the following means.

[Means 5 for Realizing the Semiconductor Circuit of the Present Invention]

The means 5 includes a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

The gate driver includes a pre-stage decoder comprising a pre-stage first decoder which decodes a bit of part of address signals for selecting the gate terminals and a pre-stage second decoder which decodes the remaining address signals, and post-stage decoders which respectively decode the respective decode outputs of the pre-stage decoders.

[Means 6 for Realizing the Semiconductor Circuit of the Present Invention]

The means 6 includes a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

The gate driver includes

a pre-stage decoder comprising a pre-stage first decoder which decodes a bit of part of address signals for selecting the gate terminals and a pre-stage second decoder which decodes the remaining bits of the address signals,

latches which respectively latch respective decode outputs of the pre-stage first decoder and the pre-stage second decoder,

level shifters which respectively shift respective voltage levels of the decode outputs of the pre-stage first decoder and the pre-stage second decoder, which are latched in the latches, to a high breakdown side, and

post-stage decoders which respectively decode the outputs of the level shifters.

[Means 7 for Realizing the Semiconductor Circuit of the Present Invention]

The means 7 includes a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

The gate driver includes

latches each comprising a first latch which latches a bit of part of the address signals for selecting the gate terminals respectively, and a second latch which latches the remaining bits,

a pre-stage decoder comprising a pre-stage first decoder which decodes the bit of the part latched in the first latch and a pre-stage second decoder which decodes the remaining bits latched in the second latch,

level shifters which respectively shift respective voltage levels of the outputs of the pre-stage first decoder and the pre-stage second decoder to a high breakdown side, and

post-stage decoders which respectively decode the output of the pre-stage first decoder and the output of the pre-stage second decoder both passed through the level shifters.

[Means 8 for Realizing the Semiconductor Circuit of the Present Invention]

The means 8 includes a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

The gate driver includes

latches each comprising a first latch which latches a bit of part of address signals for selecting the gate terminals respectively, and a second latch which latches the remaining bits,

level shifters which respectively shift respective voltage levels of the bit of the part and the remaining bits both latched in the first latch and the second latch, to a high breakdown side,

a pre-stage decoder comprising a pre-stage first decoder which decodes the output of the first latch passed through the corresponding level shifter, and a pre-stage second decoder which decodes the output of the second latch passed therethrough, and

post-stage decoders which respectively decode the decode outputs of the pre-stage first decoder and the pre-stage second decoder.

[Means 9 for Realizing the Semiconductor Circuit of the Present Invention]

The means 9 includes a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

The gate driver includes

latches each comprising a first latch which latches a bit of part of address signals for selecting the gate terminals respectively, and a second latch which latches the remaining bits,

level shifters which respectively shift respective voltage levels of the bit of the part and the remaining bits both latched in the first latch and the second latch, to a high breakdown side,

a pre-stage decoder comprising a pre-stage first decoder which decodes the output of the first latch passed through the corresponding level shifter, and a pre-stage second decoder which decodes the output of the second latch passed therethrough, and

post-stage decoders which respectively decode the decode outputs of the pre-stage first decoder and the pre-stage second decoder.

The post-stage decoders are defined as buffer decoders which share buffers provided between the pre-stage decoder and the gate terminals respectively.

Plural bits of address signals are decoded (decoded in a subsequent stage, i.e., post-decoded) again after they are decoded (decoded in a previous stage, i.e., predecoded) once, without collectively decoding them at a time. Thus, the number of level shifters can greatly be reduced.

The present invention is not limited to the invention as defined in claims. It is needless to say that various modifications can be made without departing from the technical idea of the present invention.

### BRIEF DESCRIPTION OF THE DRAWINGS

FIG. 1 is a block diagram for describing a configurational example of a gate driver section for driving a display panel, showing a first embodiment of a semiconductor circuit of the present invention;

FIG. 2 is a configurational diagram of a “1-bit” decoder DCR-A which constitutes a decoder DCR shown in FIG. 1;

FIG. 3 is a configurational diagram of a “7-bit” decoder DCR-B which constitutes the decoder DCR shown in FIG. 1;

FIG. 4 is a waveform diagram for describing the operations of gate drivers shown in FIG. 1;

FIG. 5 is a block diagram for describing a configurational example of a gate driver section for driving a display panel, showing a second embodiment of a semiconductor circuit of the present invention;

FIG. 6 is a diagram for describing a circuit configuration of a 2-bit decoder shown in FIG. 5;

FIG. 7 is a diagram for describing a circuit configuration of a 6-bit decoder shown in FIG. 5;

FIG. 8 is a block diagram for describing a configurational example of a gate driver section for driving a display panel, showing a third embodiment of a semiconductor circuit of the present invention;

FIG. 9 is a block diagram for describing a configurational example of a gate driver section for driving a display panel, showing a fourth embodiment of a semiconductor circuit of the present invention;

FIG. 10 is a block diagram for describing a configurational example of a gate driver section for driving a display panel, showing a fifth embodiment of a semiconductor circuit of the present invention;

FIG. 11 is a circuit diagram for describing a configurational example of a decoder circuit shown in FIG. 10;

FIG. 12 is a block diagram for describing a configurational example of a gate driver section for driving a display panel, showing a sixth embodiment of a semiconductor circuit of the present invention;

FIG. 13 is a circuit diagram for describing a configurational example of a buffer decoder driver shown in FIG. 12;

FIG. 14 is a waveform diagram for describing the operation of FIG. 12;

FIG. 15 is a block diagram for describing a fragmentary configurational example of a gate driver section for driving a display panel, showing a seventh embodiment of a semiconductor circuit of the present invention;

FIG. 16 is an operation waveform diagram of a buffer decoder driver BDD shown in FIG. 15;

FIGS. 17(a) and 17(b) are diagrams for describing a comparison between a layout example and one having a form previously considered by the inventors of the present application where a semiconductor circuit according to the present invention is implemented in an integrated circuit chip.

FIGS. 18(a) and 18(b) are diagrams for describing a comparison between another layout example and one having a form previously considered by the inventors of the present application where a semiconductor circuit according to the present invention is implemented in an integrated circuit chip;

FIG. 19 is a block diagram for describing a configurational example of a gate driver section for driving a display panel, showing an eighth embodiment of a semiconductor circuit of the present invention;

FIG. 20 is a block diagram for describing one example of a 1-chip type liquid crystal panel driver to which the present invention is applied;

FIGS. 21(a) and 21(b) show one example of a layout of a semiconductor integrated circuit chip of the present invention in comparison with a semiconductor integrated circuit chip of a form previously considered by the inventors of the present application;

FIG. 22 is a diagram for describing an example in which the number of decode bits and a mounting area for a semiconductor integrated circuit chip are compared where a semiconductor circuit of a form previously considered by the inventors of the present application, which collectively decodes all bits of address signals, and a two-stage decode system according to the present invention are adopted;

FIG. 23 is a diagram for describing another example in which the number of decode bits and a mounting area for a semiconductor integrated circuit chip are compared where a semiconductor circuit of a form previously considered by the inventors of the present application, which collectively decodes all bits of address signals, and a two-stage decode system according to the present invention are adopted;

FIG. 24 is a diagram for describing a further example in which the number of decode bits and a mounting area for a semiconductor integrated circuit chip are compared where a semiconductor circuit of a form previously considered by the inventors of the present application, which collectively decodes all bits of address signals, and a two-stage decode system according to the present invention are adopted;

FIG. 25 is a block diagram for describing a configurational example of a gate driver section;

FIG. 26 is a fragmentary operation waveform diagram of FIG. 25;

FIG. 27 is a diagram for describing a configurational example of a level shifter LS shown in FIG. 25;

FIG. 28 is a diagram for describing a specific circuit example of the level shifter LS shown in FIG. 25;

FIG. 29 is a diagram for describing a configurational example of a latch shown in FIG. 25;

FIG. 30 is a diagram for describing a configurational example of a 8-bit decode circuit shown in FIG. 25;

FIG. 31 is a circuit diagram for describing one example of a gateless driver;

FIG. 32 is a diagram for describing a circuit example of a shift register shown in FIG. 31;

FIG. 33 is a waveform diagram for describing the operation of FIG. 32;

FIG. 34 is a diagram for describing a reset operation using an all select signal of the semiconductor circuit showing the first embodiment of the present invention;

FIG. 35 is a diagram for indicating how noise is transferred in the semiconductor circuit of the first embodiment;

FIG. 36 is a configurational diagram of a ninth embodiment;

FIG. 37 is a configurational diagram of a circuit for controlling a reset operation of a liquid crystal driver employed in the ninth embodiment;

FIG. 38 is a diagram for describing the operation of the semiconductor circuit illustrated in the ninth embodiment;

FIG. 39 is a diagram illustrating power noise of the semiconductor circuit of the ninth embodiment; and

FIG. 40 is a diagram for describing an operation example of a semiconductor circuit illustrated in a tenth embodiment.

### DETAILED DESCRIPTION OF THE PREFERRED EMBODIMENTS

The present invention will hereinafter be explained in detail with reference to the accompanying drawings.

### First Preferred Embodiment

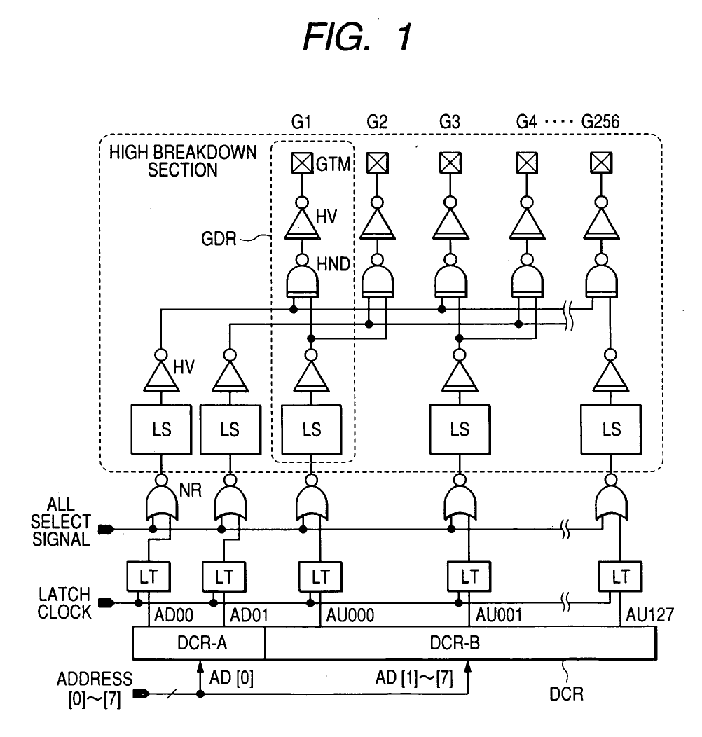

FIG. 1 is a block diagram for describing a configurational example of a gate driver section for driving a display panel, showing a first embodiment of a semiconductor circuit of the present invention. Although not restricted in particular, the present embodiment may be formed over one semiconductor substrate like a silicon single crystal. In FIG. 1, gate lines G1, G2, G3, G4, . . . G256 correspond to gate lines of the display panel. Address signals for selecting these gate lines are 8 bits. The address signals [0] through [7] of 8 bits are counted up by an unillustrated address counter, followed by being inputted to a decoder DCR.

Part “1 bit” of the inputted 8-bit address signals [0] through [7] is decoded by a pre-stage first decoder DCR-A of the decoder DCR, and so-obtained decode outputs AD00 and AD01 are respectively latched in latches LTs. This latch is performed with timing of a latch clock. The remaining “7 bits” of the address signals are decoded by a pre-stage second decoder DCR-B of the decoder DCR, and thereby decode outputs AU000, AU001 . . . . AU127 are obtained, followed by being latched in their corresponding latches LTs.

The decode outputs latched in the respective latches LTs are inputted to a high breakdown section through NOR gates NRs. A voltage level range of each latched decode output is from 3V to 0V, for example. Incidentally, shift registers can also be used as an alternative to the latches.

In the high breakdown section, the decode outputs AD00 and AD01 of “1 bit” decoded by the pre-stage first decoder DCR-A are respectively converted to a high voltage level ranging from 16V to −14V by level shifters LSs, followed by being outputted through high breakdown inverters HVs. The decode outputs AU000, AU001 . . . . AU127 of “7 bits” respectively latched in the latches LTs are converted to a high voltage level ranging from 16V to −14V by level shifters LSs, followed by being inputted to gate drivers GDRs each comprising a high breakdown NAND gate HND and a high breakdown inverter HV.

The gate drivers GDRs are provided for the gate lines G1, G2, G3, G4, . . . . G256 respectively. Level-shifted outputs of the decode outputs AD00 and AD01 of “1 bit” are inputted to one inputs of those high breakdown NAND gates HNDs. Incidentally, the NOR gates NRs are gates for turning on/off displays onto the display panel in a manner similar to FIG. 25. They are used to discharge electrical charges of pixel portions in a display section upon non-display at the time that an all select signal is inputted.

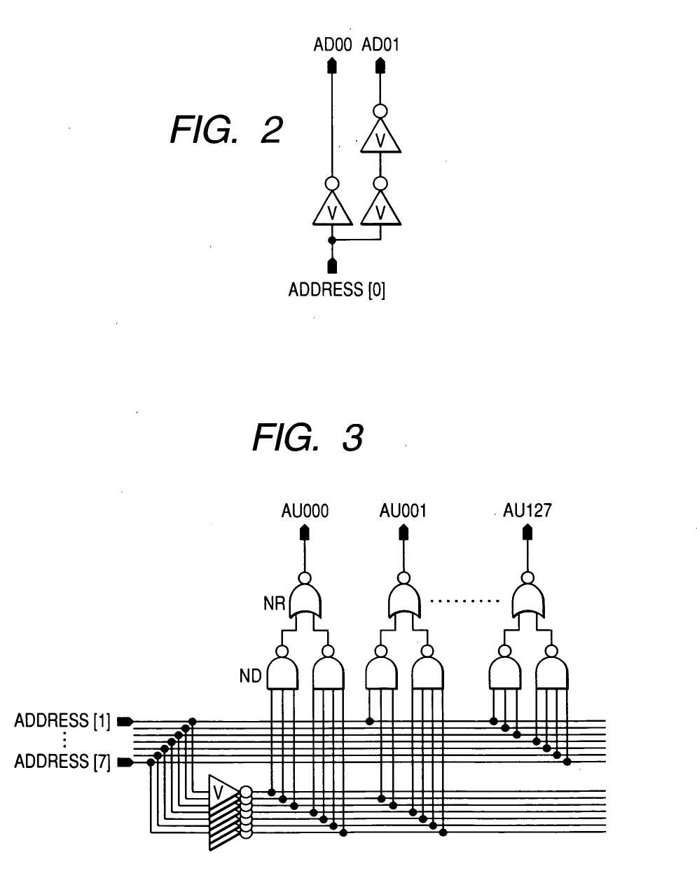

FIG. 2 is a configurational diagram of the decoder DCR-A of “1 bit” that constitutes the decoder DCR shown in FIG. 1. The decoder DCR-A comprises three inverters V and outputs the decode outputs AD00 and AD01 with respect to a bit “0” corresponding to “1 bit” of the address signals.

FIG. 3 is a configurational diagram of the decoder DCR-B of “7 bits” that constitutes the decoder DCR shown in FIG. 1. The decoder DCR-B comprises eight inverters V, six NAND gates NDs and three NOR gates NRs. The decoder DCR-B outputs the decode outputs AU000, AU001, . . . . AU127 in response to bits “1” through “7” corresponding to “7 bits” of the address signals.

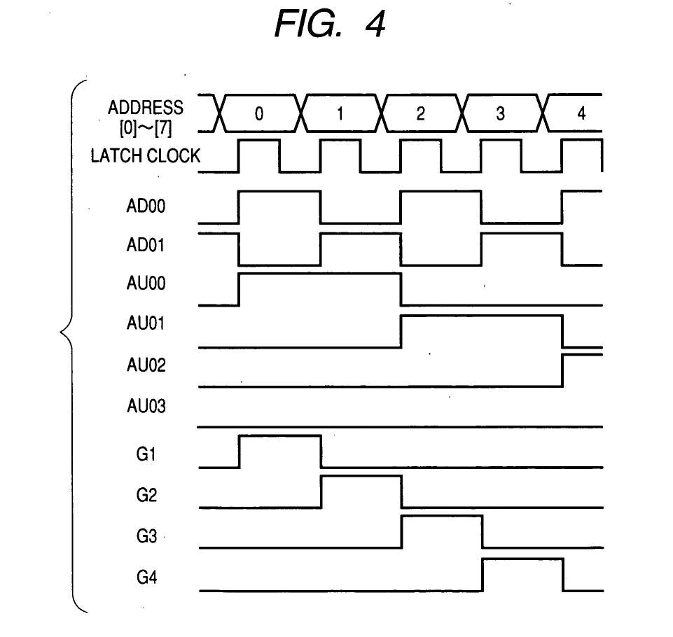

FIG. 4 is a waveform diagram for describing the operations of the gate drivers shown in FIG. 1. Signs at respective waveforms respectively correspond to sign portions in FIG. 1. In the gate drivers, the inputs of the address signals [1] through [7] are fetched into their corresponding latches in accordance with the latch clock. This fetching is performed by allowing the latch clock to be latched in the latches LTs with timing of a high level. The bit “0 corresponding to “1 bit” of the latched address signals is predecoded into AD00 and AD01, whereas the bits “1” through “7” corresponding to “7 bits” of the address signals are predecoded into AU000, AU001, . . . AU127 respectively.

The predecode outputs AD000 and AD01 of the bit “0” corresponding to “1 bit”, and the predecode outputs AU000, AU001, . . . AU127 of the bits “1” through “7” corresponding to “7 bits” are level-shifted at the high breakdown section. Thereafter, the predecode outputs AU000, AU001, . . . . AU127 of the bits “1” through “7” are decoded (post-decoded) again by their corresponding gate drivers GDRs together with the predecode outputs AD00 and AD01 of the bit “0” corresponding to “1 bit”. The so-post decoded address data are respectively supplied from gate line terminals GTMs to their corresponding gate lines as gate signals G1, G2, G3, . . . .

According to the present embodiment, the plural bits of the address signals are divided into two in arbitrary bits without collectively decoding them at a time, which in turn are respectively decoded (predecoded). Their outputs are respectively latched into the latches and the latched ones are level-shifted, followed by being decoded (post-decoded) again, whereby the number of the level shifters is greatly reduced.

Two-stage decoding in which the 8 bits of the address signals are predecoded with being divided into 1 bit and 7 bits without collectively decoding them and then post-decoded (full-decoded) after their level shifting, is performed. It is thus possible to reduce the number of level shifters to substantially half from 256 to 130 (128 +2). The two level shifters correspond to level shifters for the 1-bit address signal, whereas the 128 level shifters correspond to level shifters for the 7-bit address signals. However, although the post-decoding high breakdown NAND HNDs are added to the high breakdown section, a substantial reduction in level shifters can be realized as compared with the configuration shown in FIG. 25.

Incidentally, although the 1 bit of the address signals to be divided may be an arbitrary bit, it may preferably be either the most significant bit or the least significant bit in consideration of ease of a circuit configuration. In order to minimize wiring routing, it may preferably be set to a lower 1 bit.

### Second Preferred Embodiment

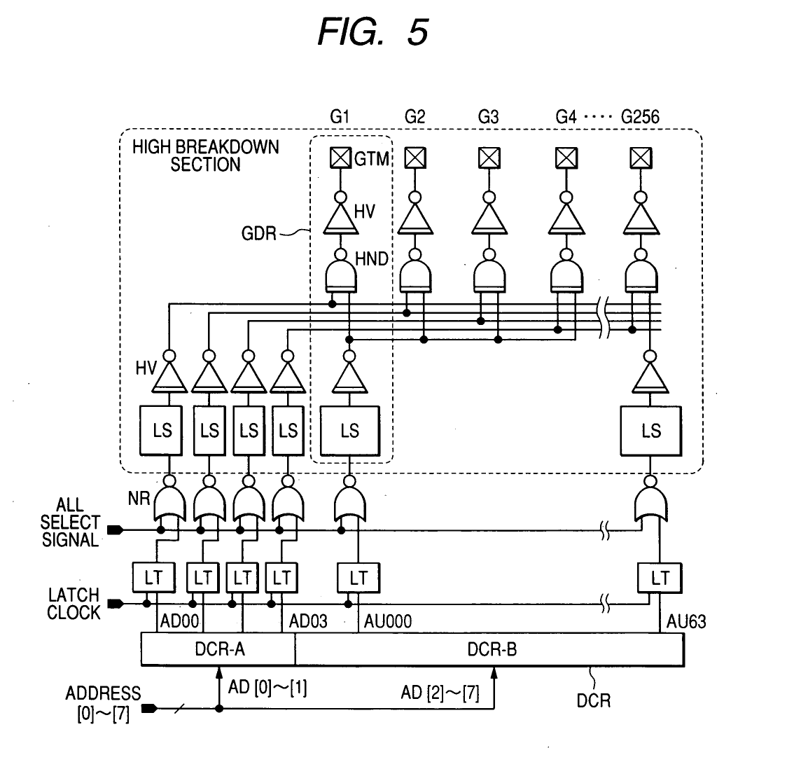

FIG. 5 is a block diagram for describing a configurational example of a gate driver section for driving a display panel, which shows a second embodiment of a semiconductor circuit of the present invention. In the present embodiment, address signals of 8 bits are decoded with being divided into 2 bits and 6 bits. In the figure, the same reference numerals as those shown in FIG. 1 correspond to the same functional portions. In the present embodiment, the address signals [0] through [7] of 8 bits are divided into address signals AD[0] and AD[1] of 2 bits and address signals AD[2] through AD[7] of 6 bits. A predecoding decoder DCR comprises a pre-stage first decoder DCR-A and a pre-stage second decoder DCR-B.

The address signals AD[0] and AD[1] of 2 bits are decoded by the pre-stage first decoder DCR-A into decode outputs AD00 through AD03, which are then latched into their corresponding latches LTs. This latching is performed with timing of a latch clock. The remaining address signals AD[2] through AD[7] of “7 bits” in the address signals are respectively decoded by the pre-stage second decoder DCR-B to obtain decode outputs AU00 through AU63. The decode outputs AU00 through AU63 are latched in their corresponding latches LTs. Thereafter, they are full-decoded by their corresponding post decoders in a manner similar to the first embodiment, which in turn are respectively supplied from gate line terminals GTMs to their corresponding gate lines as gate signals G1, G2, G3, . . . .

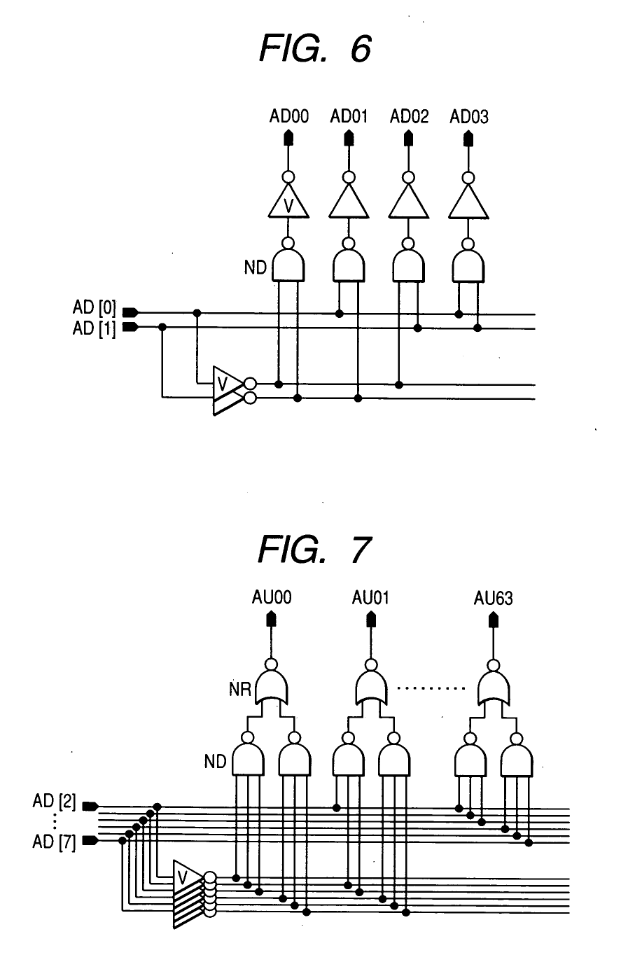

FIG. 6 is an explanatory diagram of a circuit configuration of a 2-bit decoder shown in FIG. 5, and FIG. 7 is an explanatory diagram of a circuit configuration of a 6-bit decoder shown in FIG. 5, respectively. The 2-bit decoder comprises two inverters V, four NAND gates NDs and four inverters V respectively connected to output terminals of the NAND gates NDs. The 6-bit decoder comprises six inverters V, 128 NAND gates NDs and 64 NOR gates NRs respectively connected to output terminals of the NAND gates NDs.

According to the present embodiment, the number of level shifters can be set to substantially ¼ equivalent to 68 (64+4), of 256 in FIG. 25. The four level shifters LSs are level shifters for the address signals of 2 bits, and the 64 level shifters are level shifters for the address signals of 6 bits. However, although post decoding high breakdown NAND circuits HNDs are added to a high breakdown section, a substantial reduction in level shifters can be realized as compared with the configuration shown in FIG. 25. Although the number of level shifters in the present configuration becomes 68, the number thereof becomes 32 at minimum when the address signals are divided into 4 bits and 4 bits.

### Third Preferred Embodiment

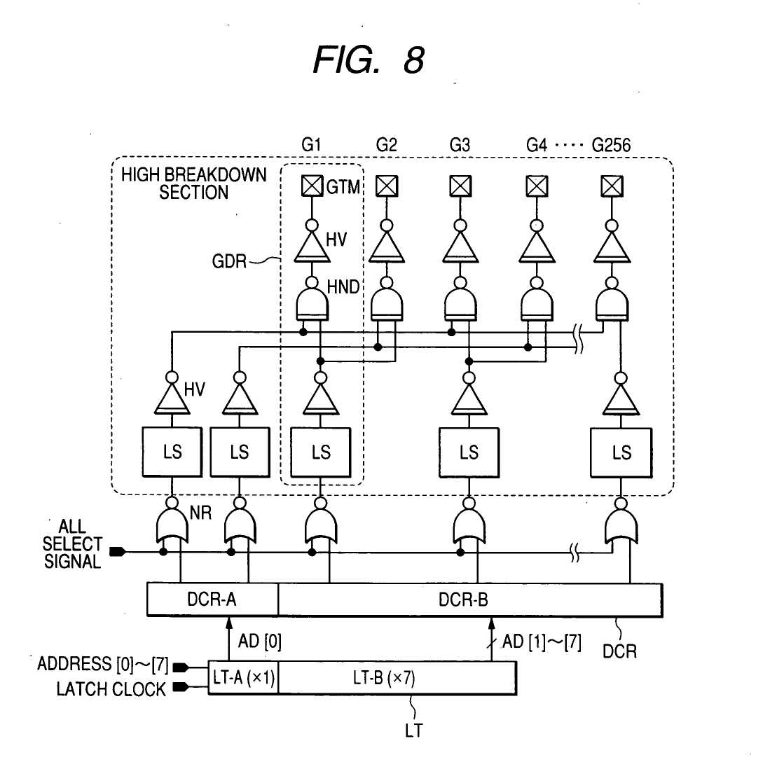

FIG. 8 is a block diagram for describing a configurational example of a gate driver section for driving a display panel, which shows a third embodiment of a semiconductor circuit of the present invention. The present embodiment is equivalent to one wherein latches for latching address signals of 8 bits are placed in a stage prior to a predecoder. And the address signals of 8 bits are latched as follows. The latch LT comprises a first latch LT-A and a second latch LT-B. The first latch LT-A latches the address signal AD[0] of 1 bit in the inputted address signals of 8 bits therein, and the second latch LT-B latches the address signals AD[1] through AD[7] in the inputted 8-bit address signals therein.

The AD[0] latched in the first latch LT-A is decoded by a first decoder DCR-A of the predecoder DCR, and the AD[1] through AD[7] latched in the second latch LT-B are decoded by a second decoder DCR-B thereof. Other configurations are similar to FIG. 1. Thereafter, they are full-decoded by post decoders in a manner similar to the first embodiment, which in turn are respectively supplied from gate line terminals GTMs to their corresponding gate lines as gate signals G1, G2, G3, . . . .

According to the present embodiment, the plural bits of the address signals are divided into two in arbitrary bits without collectively decoding them at a time, which in turn are respectively latched in the latches. The latched address signals are respectively decoded (predecoded) and the so-predecoded address signals are level-shifted, followed by being decoded (post-decoded) again, whereby the number of level shifters is greatly reduced. Thus, the number of the level shifters can be reduced to substantially ½ equivalent to 130 (128+2) from 256 in FIG. 25. A substantial reduction in level shifters can be realized as compared with the configuration shown in FIG. 25 wherein the two level shifters are level shifters for the 1-bit address signal, and the 128 level shifters are level shifters for the 7-bit address signals.

Incidentally, although the 1 bit of the address signals to be divided may be an arbitrary bit, it may preferably be either the most significant bit or the least significant bit in consideration of ease of a circuit configuration. In order to minimize wiring routing, it may preferably be set to a lower 1 bit.

### Fourth Preferred Embodiment

FIG. 9 is a block diagram for describing a configurational example of a gate driver section for driving a display panel, which shows a fourth embodiment of a semiconductor circuit of the present invention. In the present embodiment, latches for latching 8-bit address signals therein are placed in a stage prior to a predecoder and level shifters are disposed in association with the outputs of the latches. Other configurations are similar to FIG. 8.

A 1-bit address signal AD[0] of the inputted 8-bit address signals AD[0] through AD[7] is latched in a first latch LT-A of a latch LT, and the remaining 7-bit address signals AD[1] through AD[7] are latched in a second latch LT-B. The address signal AD[0] latched in the latch LT-A is decoded by a first decoder DCR-A of a predecoder DCR, and the address signals AD[1] through AD[7] latched in the second latch LT-B are decoded by a second decoder DCR-B. Its subsequent signal processing is similar to FIGS. 1 and 8.

According to the present embodiment, the plural bits of the address signals are divided into two in arbitrary bits without collectively decoding them at a time, which in turn are respectively latched in the latches. The latched address signals are respectively level-shifted and the outputs of the latches are decoded (post-decoded) again after their decoding (predecoding), whereby the number of level shifters is greatly reduced. Since the number of level shifters LSs may be the number of bits of the address signals because the level shifters LSs are placed in a stage prior to the decoder DCR, the level shifters can further be reduced as compared with the first, second and third embodiments.

### Fifth Preferred Embodiment

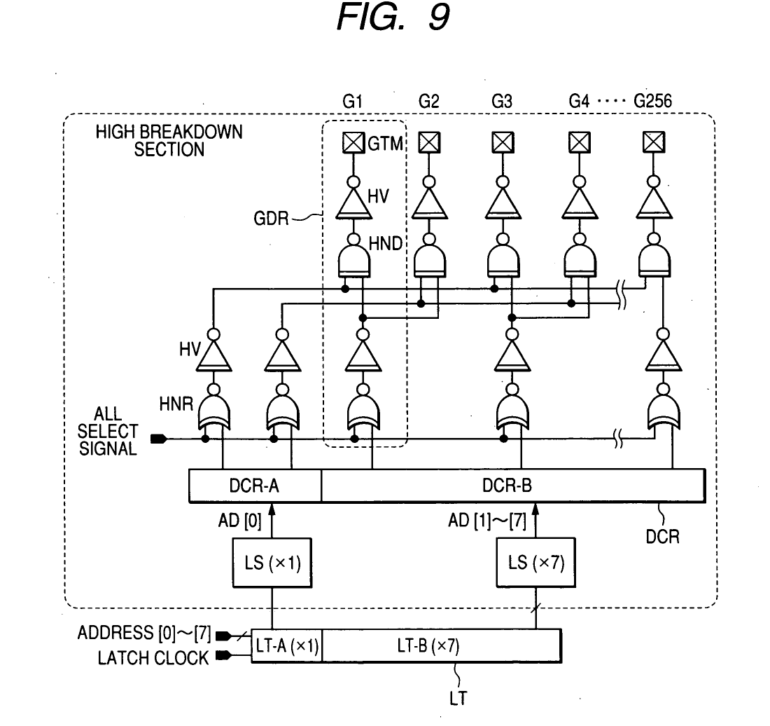

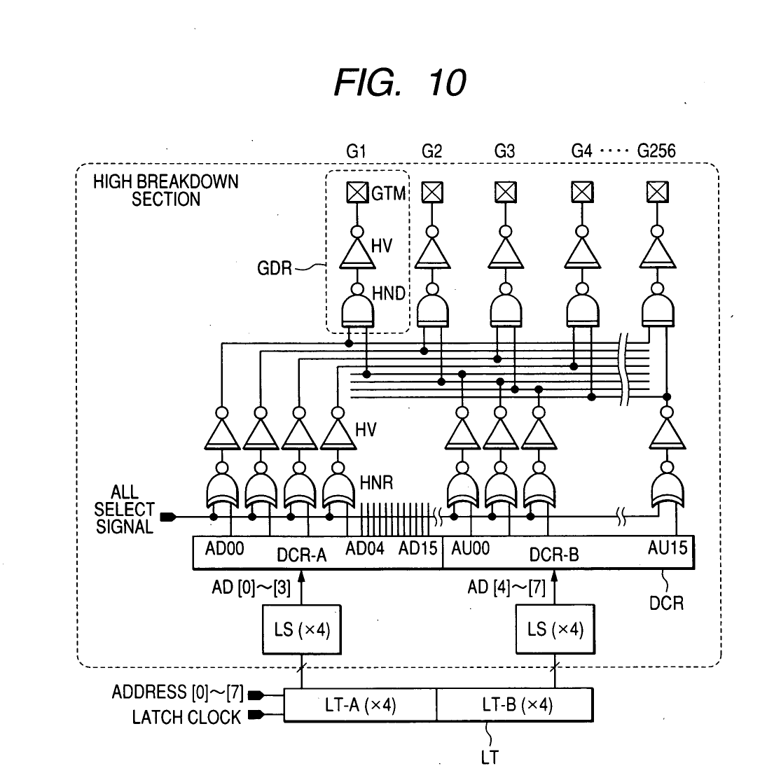

FIG. 10 is a block diagram for describing a configurational example of a gate driver section for driving a display panel, which shows a fifth embodiment of a semiconductor circuit of the present invention. In the present embodiment, latches LTs for latching input address signals are placed in a stage prior to a predecoder DCR and level shifters LSs are disposed in association with the outputs of the latches LTs. The address signals of 8 bits are divided into address signals AD[0] through AD[3] of 4 bits and AD[4] through AD[7] thereof. Other configurations and operations are similar to FIG. 9.

According to the present embodiment, the 4-bit address signals AD[0] through AD[3] are latched into a first latch LT-A, and the remaining 4-bit address signals AD[4] through AD[7] are latched into a second latch LT-B. Four level shifters LSs are disposed in association with the output of the first latch LT-A, and four level shifters LSs are disposed in association with the output of the second latch LT-B. The predecoder DCR is connected to the outputs of the respective four level shifters LSs. The predecoder DCR comprises a first decoder DCR-A and a second decoder DCR-B each corresponding to the four level shifters LSs. The outputs of the respective four level shifters LSs are respectively inputted to the first decoder DCR-A and second decoder DCR-B associated with the respective four level shifters LSs, where they are predecoded. Post decoders and other configurations and operations are similar to FIG. 9.

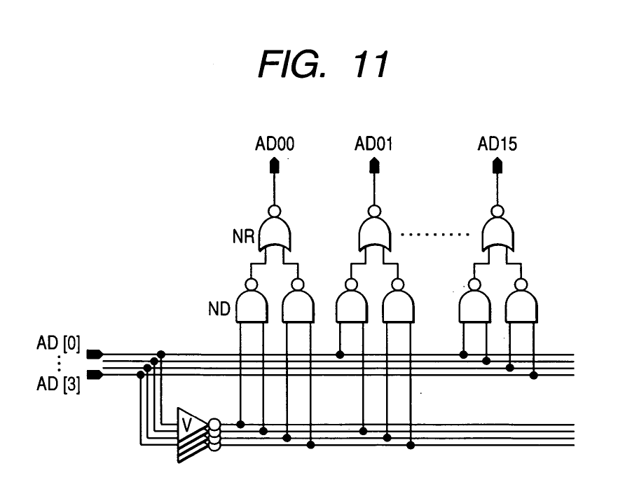

FIG. 11 is a circuit diagram for describing a configurational example of a decoder in FIG. 10. The 4-bit decoder comprises four inverters V, 32 NAND gates NDs and 16 NOR gates NRs. The 4-bit decoder is inputted with addresses AD[0] through AD[3] and outputs decoded address signals AD00 through AD15.

According to the present embodiment, the plural bits of the address signals are divided into two in arbitrary bits without collectively decoding them at a time, which in turn are respectively latched in the latches. The latched address signals are respectively level-shifted and the outputs of the latches are decoded (post-decoded) again after their decoding (predecoding), whereby the number of level shifters is greatly reduced. Since the number of level shifters LSs may be the number of bits of the address signals because the level shifters LSs are placed in a stage prior to the decoder DCR, the level shifters can further be reduced as compared with the first, second and third embodiments. The number of elements in the predecoder can greatly be reduced as compared with FIG. 9. Although each of the first through fifth embodiments has illustrated the example in which the level shifters LSs are disposed before and after the predecoder, the position of placement of each level shifter whose area is minimized, is determined depending upon the area ratio between the level shifter and the decoder DCR. Incidentally, the area of each level shifter might be restricted by the number of signal lines for predecode signals or the like.

### Sixth Preferred Embodiment

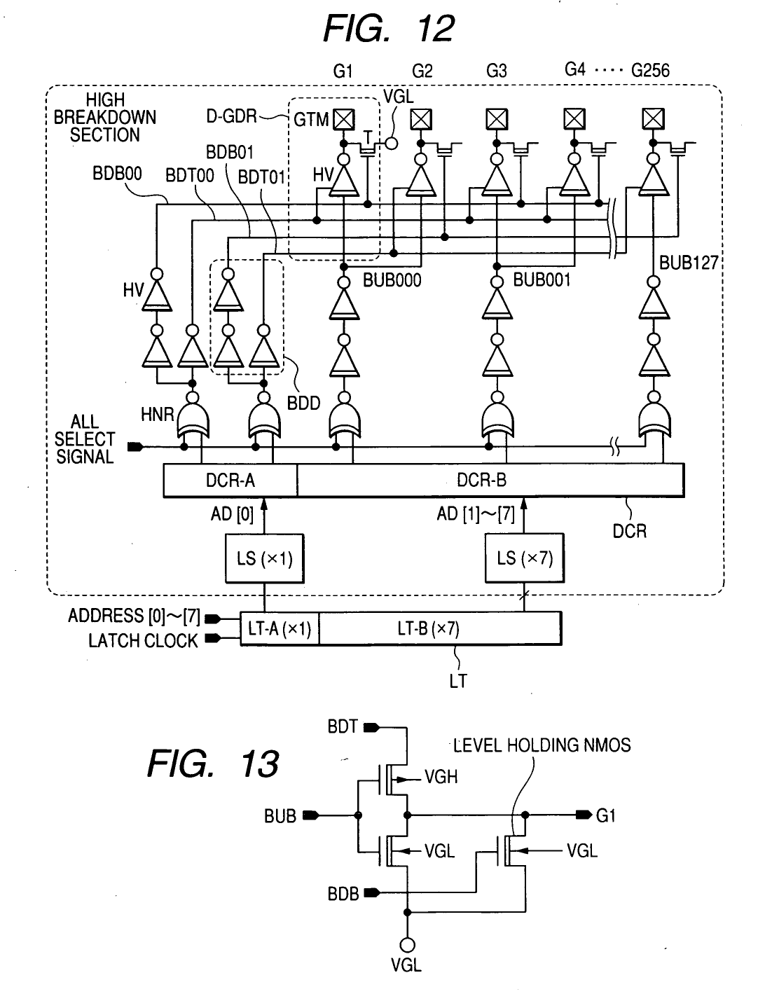

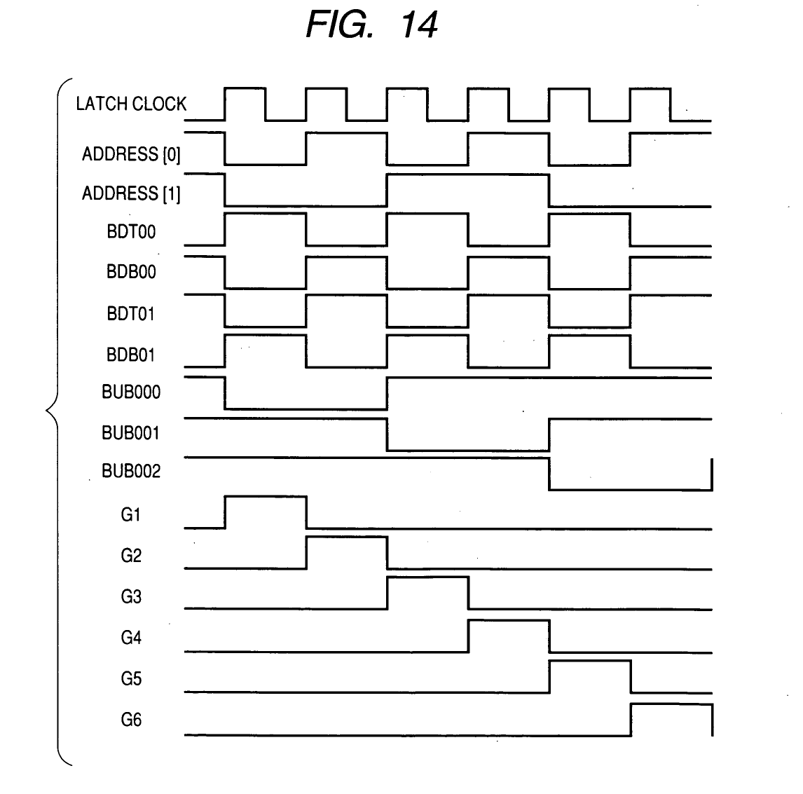

FIG. 12 is a block diagram for describing a configurational example of a gate driver section for driving a display panel, which shows a sixth embodiment of a semiconductor circuit of the present invention. FIG. 13 is a circuit diagram for describing a configurational example of a buffer decoder driver shown in FIG. 12, and FIG. 14 is a waveform diagram for describing the operation of FIG. 12, respectively. In the present embodiment, post decoders are configured integrally with buffer circuits comprising gate drivers for driving respective gate lines to thereby form decoder integral-type gate drivers D-GDRs. That is, post decode functions are added to buffers of the gate drivers. In FIG. 12, one bit of inputted 8-bit address signals is latched in a first latch LT-A of a latch LT, and the remaining 7 bits are latched in a second latch LT-B of the latch LT. This configuration and processing up to a predecoder or predecode circuit DCR are similar to FIG. 9.

The outputs of a first decoder DCR-A of the predecoder DCR are respectively inputted to buffer decoder drivers BDDs through high breakdown NOR gates HNRs. Each of the buffer decoder drivers BDDs comprises three high breakdown inverters HVs. Waveforms inputted to respective terminals respectively correspond to waveforms of the same signs in FIG. 14. The outputs of the buffer decoder drivers BDDs are inputted to their corresponding decoder integral-type gate drivers D-GDRs each having the post decode function. As shown in FIG. 13, the decoder integral-type gate driver D-GDR comprises NMOS and PMOS transistors.

Incidentally, the outputs of a second decoder DCR-B of the predecoder DCR are respectively inputted to the decoder integral-type gate drivers D-GDRs corresponding to the respective two gate lines through high breakdown NOR gates HBRs and two high breakdown inverters HVs.

A predecoded signal is inputted to the source of PMOS of the high breakdown inverter HV that constitutes each decoder integral-type gate driver D-GDR. When the predecoded signal inputted to the source of PMOS is brought to a low level, its output is also brought to a low level. However, the above output is not fully brought to the low level at this time. To this end, a level holding NMOS transistor is added as shown in FIG. 13. Thus, the high breakdown NAND gates HNDs shown in FIG. 9, for example can be cut down.

An operation example is mentioned here. When addresses ADs are all “0”, the output BDT00 of the buffer decoder driver BDD is high in level and the output BDB00 thereof is low in level, and the output BUB000 of the second decoder DCR-B is low in level. In this condition, the output to the gate line G1 is selected. When only the address [0] is now changed to “1”, BDT00 becomes low in level and BDB00 becomes high in level. Since BUB00 is low in level here, a current flows between the source and drain of PMOS so that G1 approaches a low level. When the difference in voltage between BUB00 and G1 becomes less than or equal to the threshold voltage of PMOS, PMOS is turned off so that G1 is brought to floating. However, G1 is held low in level by the level holding NMOS transistor, i.e., G1 is held at a VGL level.

According to the present embodiment, buffer circuits for gate drivers are caused to have decode functions respectively. They are allowed to function as post decoders which use control signals generated from predecoded signals of bits of address signals. Thus, the number of level shifters can greatly be reduced. NANDs HNDs of post decoder circuits become unnecessary and hence their areas can be reduced.

### Seventh Preferred Embodiment

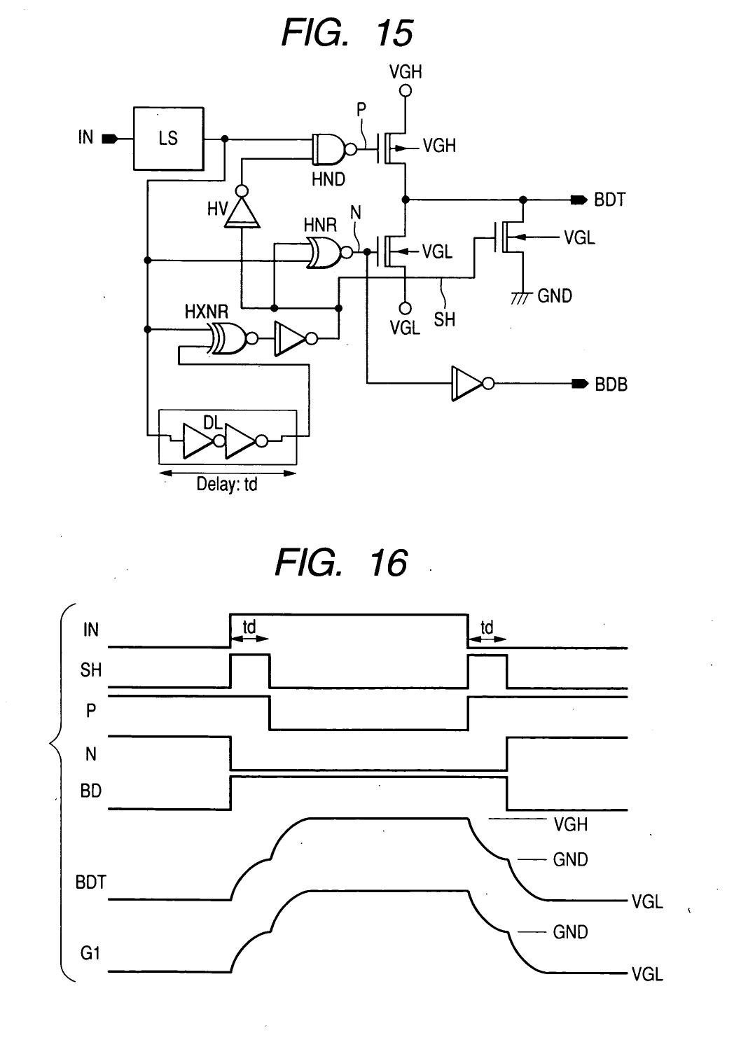

FIG. 15 is a block diagram for describing a fragmentary configurational example of a gate driver section for driving a display panel, which shows a seventh embodiment of a semiconductor circuit of the present invention. FIG. 15 is another configurational example of the buffer decoder driver BDD shown in FIG. 12. Configurations other than the buffer decoder driver BDD are similar to FIG. 12. FIG. 16 is an operation waveform diagram of the buffer decoder driver BDD shown in FIG. 15.

In FIG. 15, a circuit constituted of a level shifter LS, a delay circuit DL, a high breakdown exclusive NOR gate HXNR, two high breakdown inverters HVs, a high breakdown NAND gate HNDs and a high breakdown NOR gate HNR is added to the circuit shown in FIG. 13 to thereby configure a buffer decoder driver BDD with a short function.

Since the voltages outputted to the gate lines are supplied via the buffer decoder drivers BDDs in the configuration of FIG. 12, power is consumed or used up. In the present embodiment, the short function shown in FIG. 15 is added to temporarily short each gate voltage to a ground GND or the like. Thus, a gate charge/discharge current is reduced and an increase in area can be suppressed.

Waveforms shown in FIG. 16 respectively indicate waveforms at portions designated at the same symbols in FIG. 15. As shown in FIG. 16, rising and falling intermediate sections of a waveform of the buffer decoder driver BDD and a gate output (only G1 is shown here) waveform respectively have inflexion points (corresponding to points where the rate of change in increase or decrease is reversed in positive and negative) on the rising and falling edges of a P-point output brought to a low level with timing delayed by the delay circuit DL shown in FIG. 15.

According to the present embodiment, the operation of each post decoder can be confirmed by virtue of the inflexion point of the waveform outputted to each of the gate terminals.

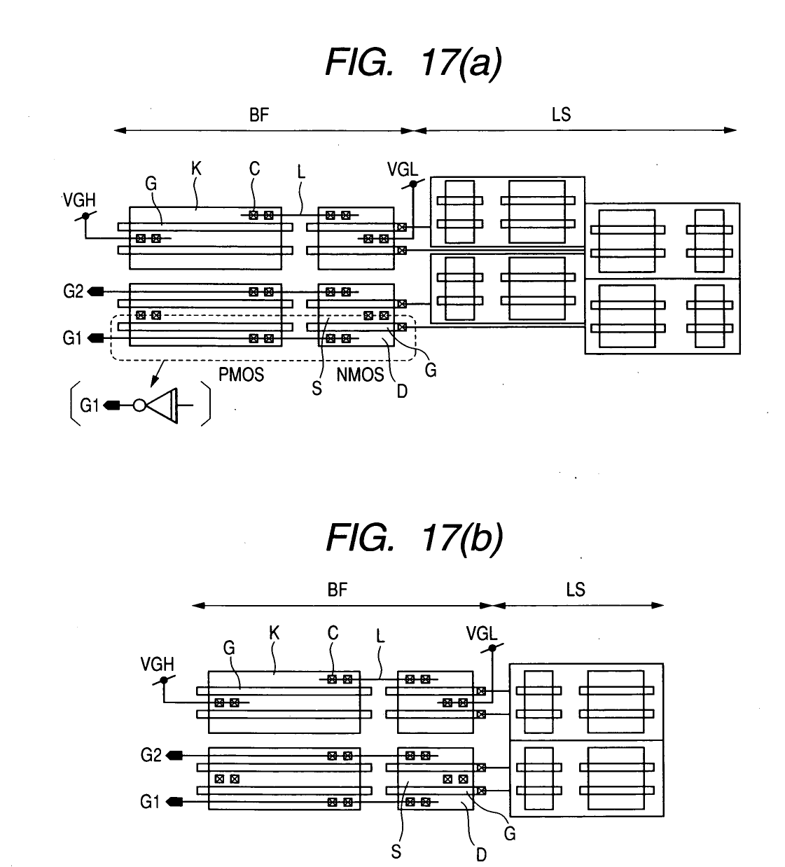

FIGS. 17(a) and 17(b) are diagrams for describing a comparison between a layout example and one having a form previously considered by the inventors of the present application where a semiconductor circuit according to the present invention is implemented in an integrated circuit chip, wherein FIG. 17(a) shows a layout of the form previously considered by the inventors of the present application, and FIG. 17(b) shows a layout of the present invention, respectively. FIG. 17(b) is equivalent to the embodiment of the present invention where the inputted address signals are divided into one bit and seven bits to execute two-stage decoding.

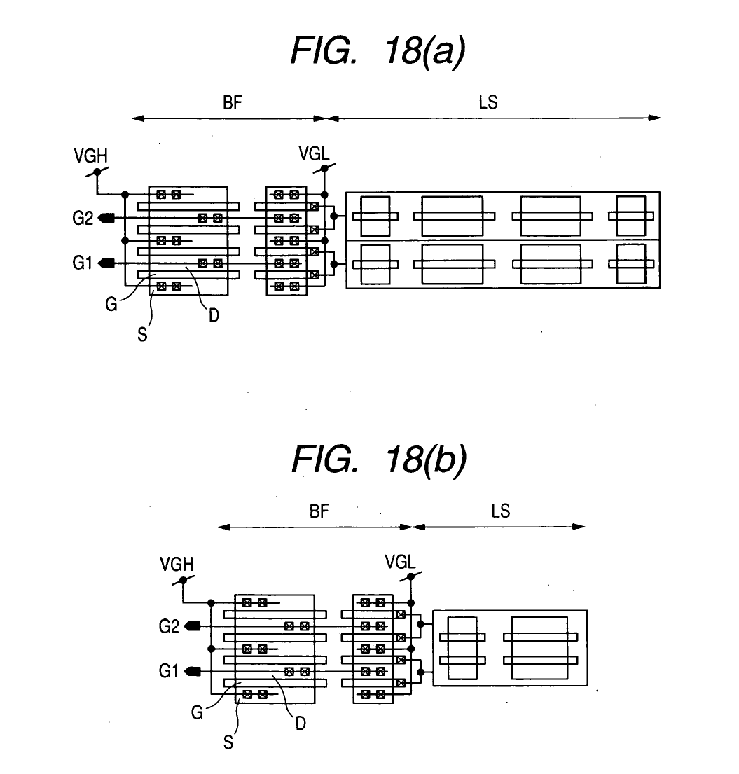

In each of FIGS. 17(a) and 17(b), the left half is a section corresponding to a buffer BF, and the right half is a section corresponding to a level shifter. The buffer BF comprises PMOS and NMOS transistors and is constituted of their diffusion layers K, gate layers G, contact layers C, wiring layers L, and electrodes of gates, sources and drains. Incidentally, the buffers BFs in FIGS. 17(a) and 17(b) and FIGS. 18(a) and 18(b) to be described later are inverters HVs directly connected to the gate line terminals GTMs employed in the respective embodiments shown in FIGS. 1, 5, 8, 9, 10 and 12.

As is apparent from a comparison between FIGS. 17(a) and 17(b), the number of the level shifters LSs wherein the 8-bit address signals in each embodiment of the present invention shown in FIG. 17(b) are divided into one bit and seven bits, which in turn are decoded in the form of two stages of predecode and post decode, is smaller than the integrated circuit chip shown in FIG. 17(a). A mounting area corresponding to the number thereof may be small and a small-sized integrated circuit chip can be realized.

FIGS. 18(a) and 18(b) are diagrams for describing a comparison between another layout example and one having a form previously considered by the inventors of the present application where a semiconductor circuit according to the present invention is implemented in an integrated circuit chip, wherein FIG. 18(a) shows a layout of the form previously considered by the inventors of the present application, and FIG. 18(b) shows a layout of the present invention. FIG. 18(b) is also equivalent to the embodiment of the present invention where the inputted address signals are divided into one bit and seven bits to execute two-stage decoding.

Although source electrodes of MOS transistors are shared with source electrodes of MOS transistors adjacent thereto in FIGS. 18(a) and 18(b) to reduce mounting areas, the embodiment of the present invention shown in FIG. 18(b) is substantially reduced in the number of level shifters. Accordingly, the mounting area may be small and hence a small-sized integrated circuit chip can be realized. The number of the level shifters is smaller than the number of gate line terminals GTM for outputting the gate signals and thereby the degree of freedom of a layout increases. Further, a mounting area may be small and hence a small-sized integrated circuit chip can be realized. The number of level shifters LSs is smaller than the number of output buffers BFs and thereby the degree of freedom of a layout increases. Further, a mounting area may be small and hence a small-sized integrated circuit chip can be realized.

### Eighth Preferred Embodiment

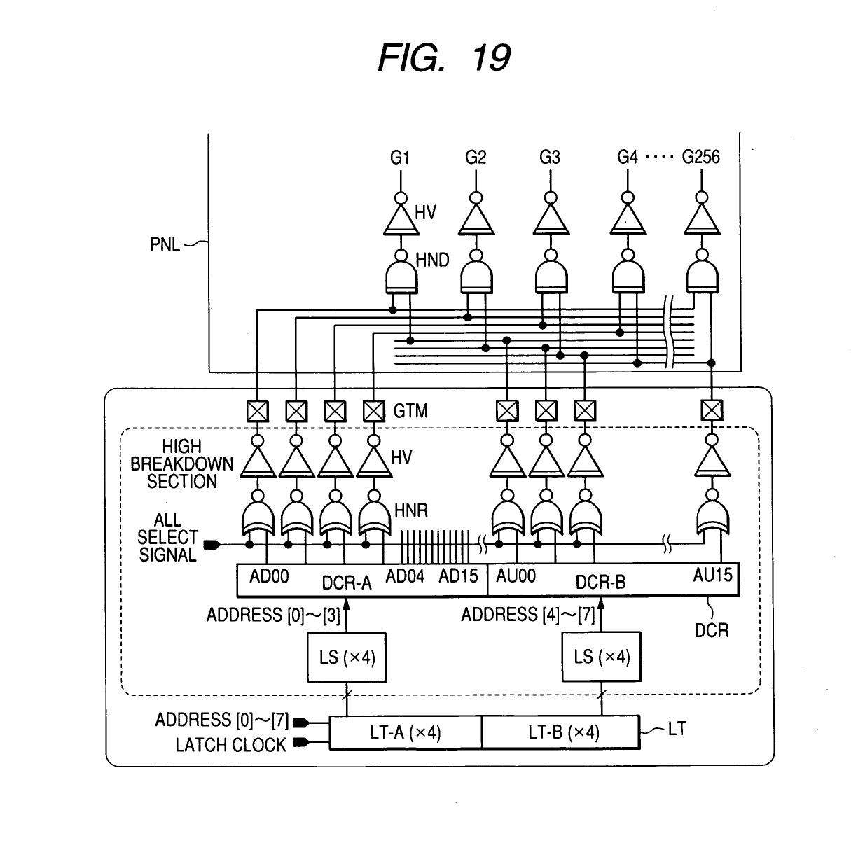

FIG. 19 is a block diagram for describing a configurational example of a gate driver section for driving a display panel, which shows an eighth embodiment of a semiconductor circuit of the present invention. In the present embodiment, gate drivers are built in the display panel PNL. Each of the built-in gate drivers comprises a thin film transistor made up of, for example, a low-temperature polysilicon semiconductor. Gate driver sections for generating address signals in the display panel will be referred to as “gateless drivers” here. In the present embodiment, inputted 8-bit address signals are latched in a latch LT. The latch LT comprises a first latch LT-A and a second latch LT-B for respectively latching 4 bits therein and latches the address signals four bits by four bits.

The address signals of 4 bits latched in the first latch LT-A and the second latch LT-B are respectively level-shifted by level shifters LSs, which in turn are inputted to a decoder DCR. The decoder DCR comprises a first decoder DCR-A and a second decoder DCR-B and decodes the 4 bits of the level-shifted address signals respectively. The outputs of the first decoder DCR-A and the second decoder DCR-B are supplied to their corresponding terminals GTMs connected to gate lines of the display panel, through high breakdown NOR gates HNRs and high breakdown inverters HVs. Thus, in the present embodiment, the shift registers SRs on the panel GIPNL necessary for the form previously considered by the inventors of the present application can be substituted with one NAND HND, thus making it possible to reduce the area of the display panel. Further, the number of the level shifters can greatly be reduced and hence the area of a semiconductor integrated circuit of the present invention can be reduced.

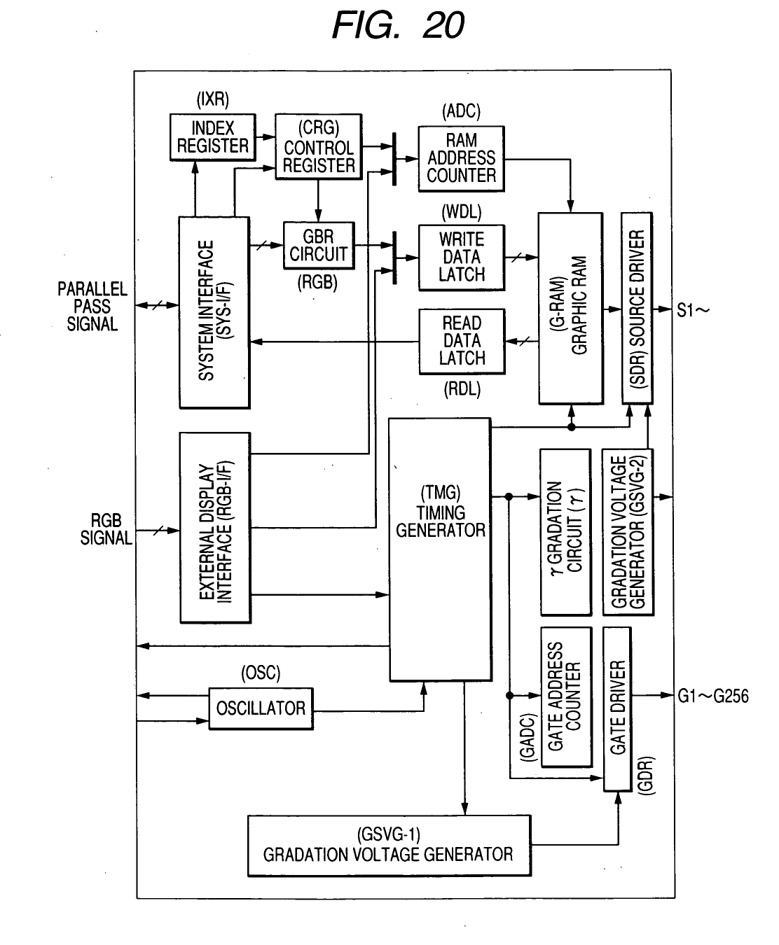

FIG. 20 is a block diagram for describing one example of a 1-chip type liquid crystal display panel driver to which the present invention is applied. The 1-chip type liquid crystal display panel driver has a system interface SYS-I/F connected to an external signal source by means of a parallel bus, an external display interface RGB-I/F inputted with display data of RGB, a timing generator TMG, a graphic RAM G-RAM, a source driver SDR, a gate driver GDR, and gradation voltage generators GSVG-1 and GSVG-2. In addition to the above, the 1-chip type liquid crystal display panel driver includes an index register IXR, a control register CRG, a BGR circuit BGR (RGB to BGR conversion), a RAM address counter ADC, a write data latch WDL, a read data latch RDL, a gamma gradation circuit y, a gate address counter GADC, an oscillator OSC, etc.

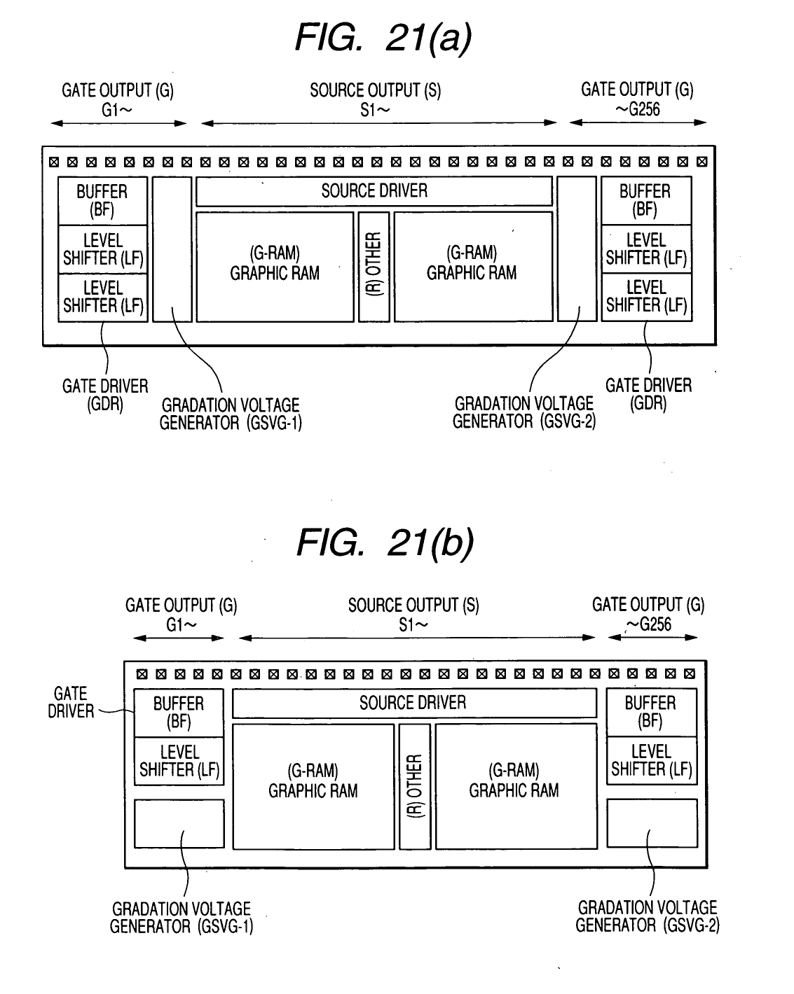

FIGS. 21(a) and 21(b) show one example of a layout of a semiconductor integrated circuit chip of the present invention in comparison with a semiconductor integrated circuit chip of a form previously considered by the inventors of the present application, wherein FIG. 21(a) shows a 1-chip type liquid crystal display panel driver of a form previously considered by the inventors of the present application, and FIG. 21(b) shows a 1-chip type liquid crystal display panel driver of the present invention, respectively. According to the layout of the form previously considered by the inventors of the present application, graphic G-RAMs are divided into two at its central portion and mounted thereat, and source terminals S are provided. Respective two level shifters LSs, respective one buffers BFs and gradation voltage generators GSVG-1 and GSVG-2 are disposed on both sides of the graphic RAMs G-RAMs, and gate output terminals are provided, respectively.

It is understood that in the semiconductor integrated circuit chip of the present invention as shown in FIG. 21(b), the number of the level shifters LSs is small as compared with the chip of the form previously considered by the inventors of the present application shown in FIG. 21(a), and hence the size of the whole layout is reduced. Since the area of each level shifter LS is small, the degree of freedom of its layout increases. In the case of a chip free of the semiconductor integrated circuit with each gate driver as single, or of the graphic RAM G-RAM, a further reduction in its size and the degree of freedom of its layout increase.

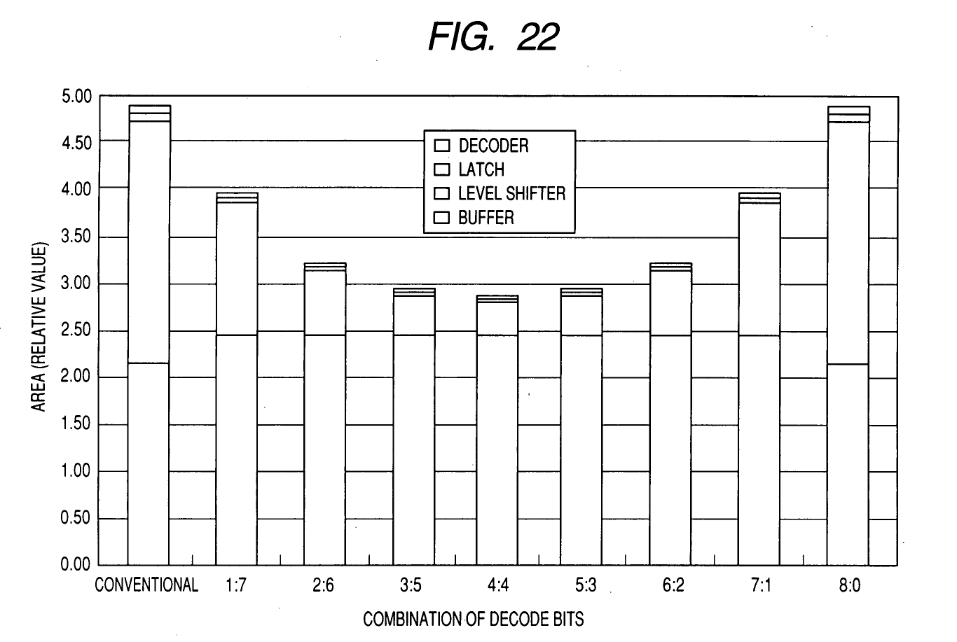

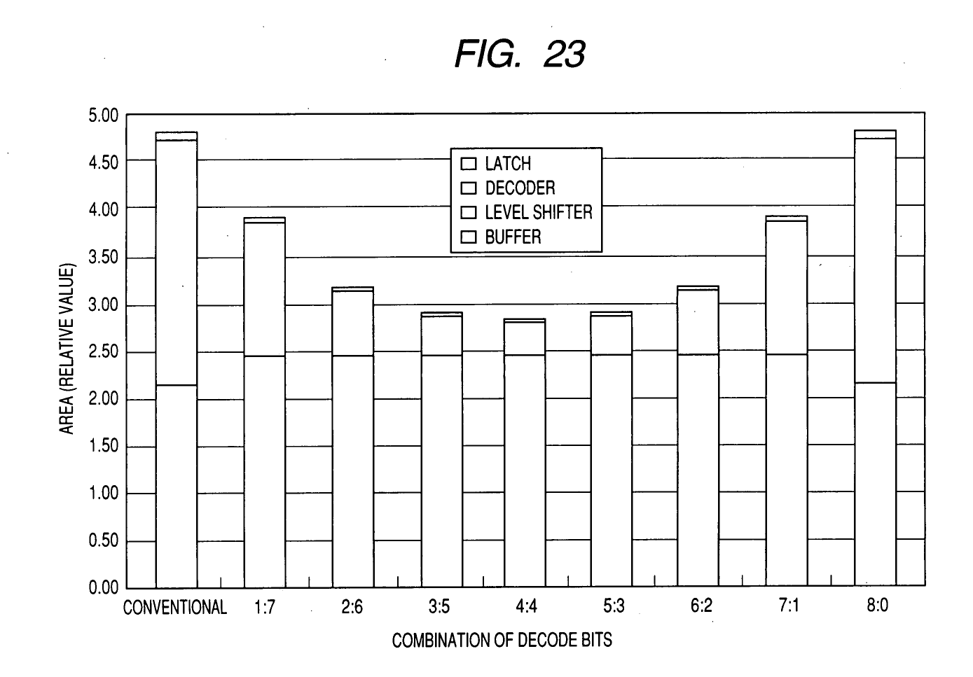

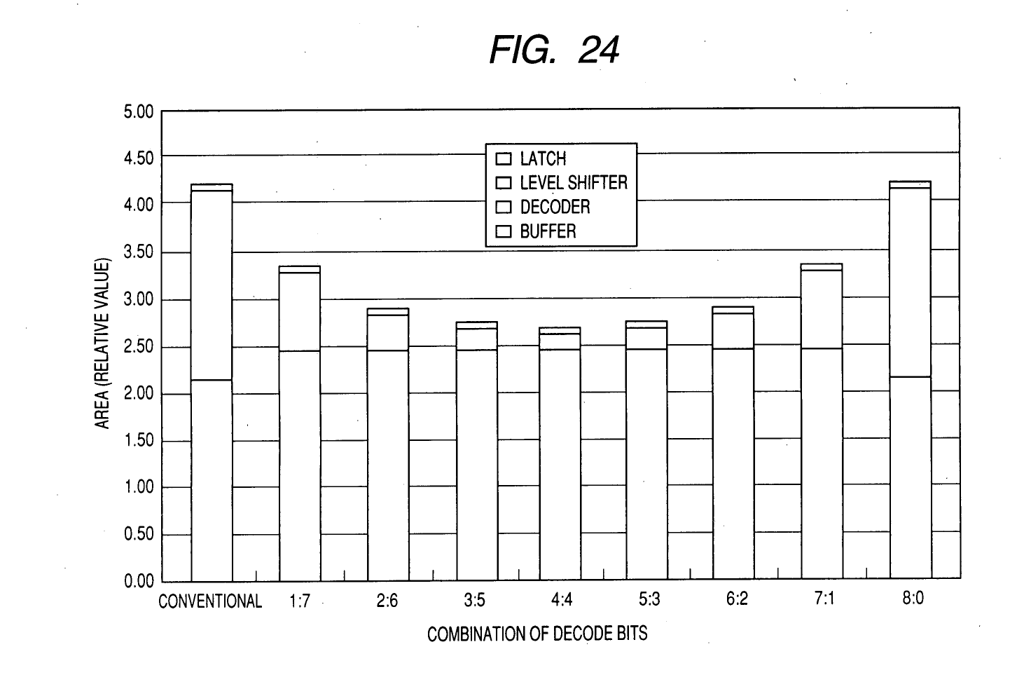

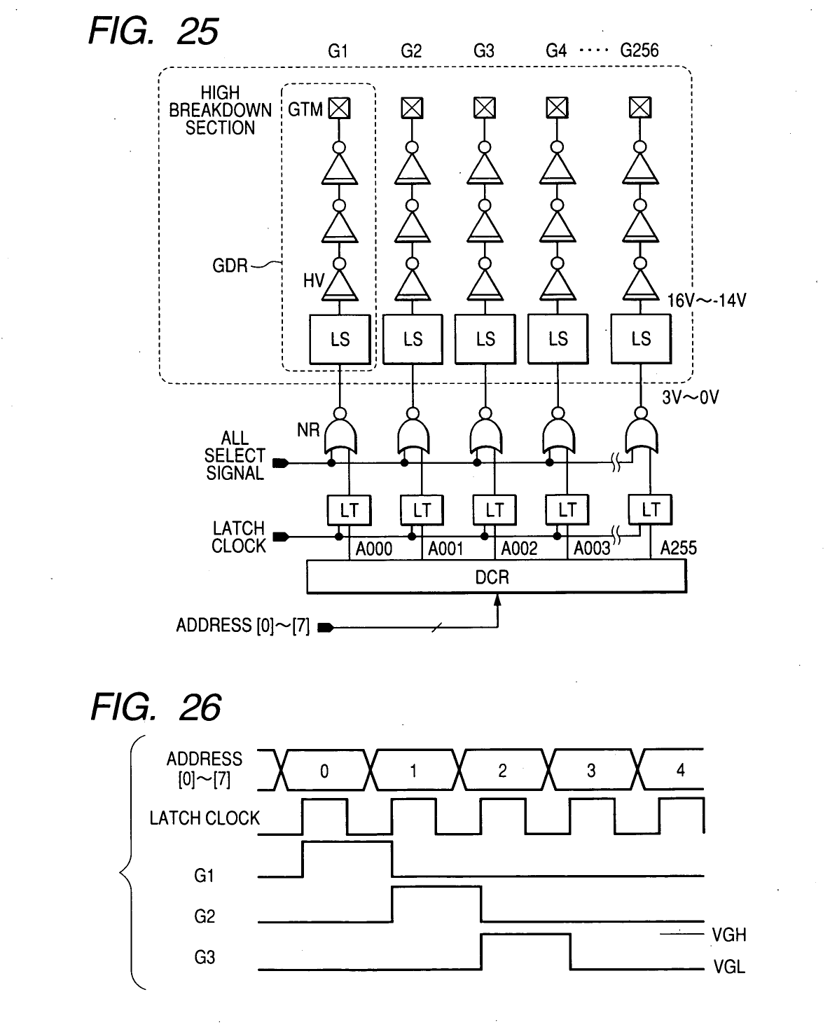

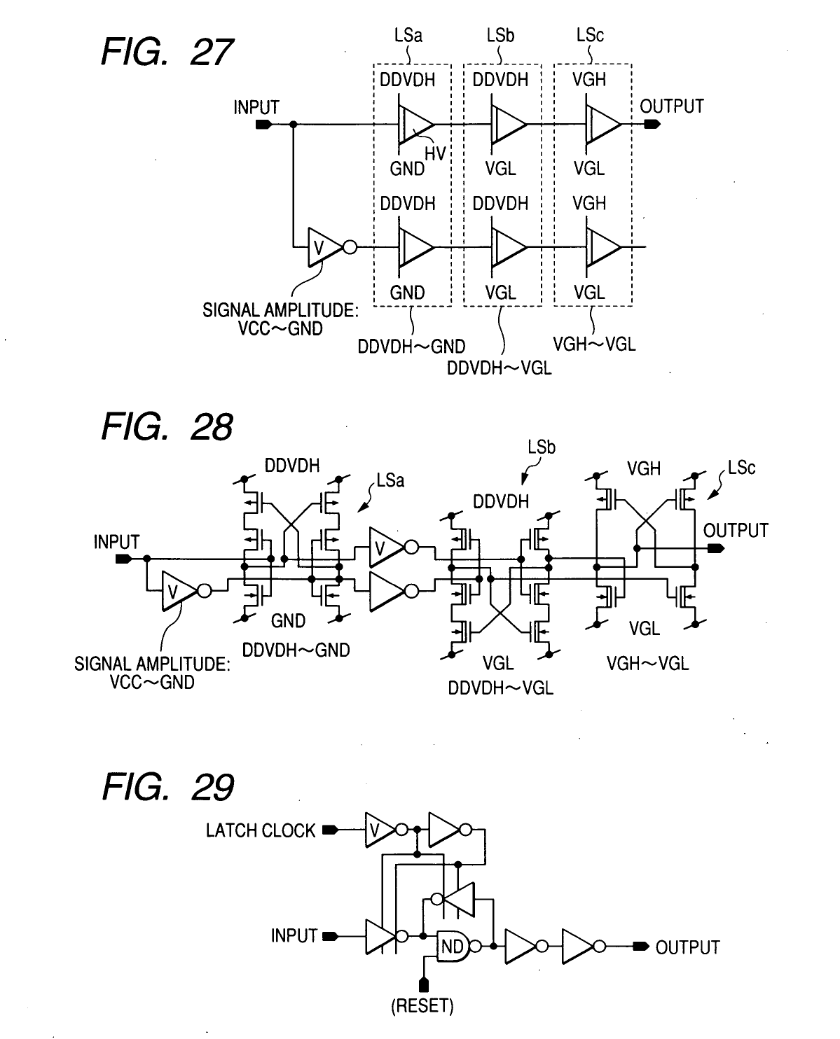

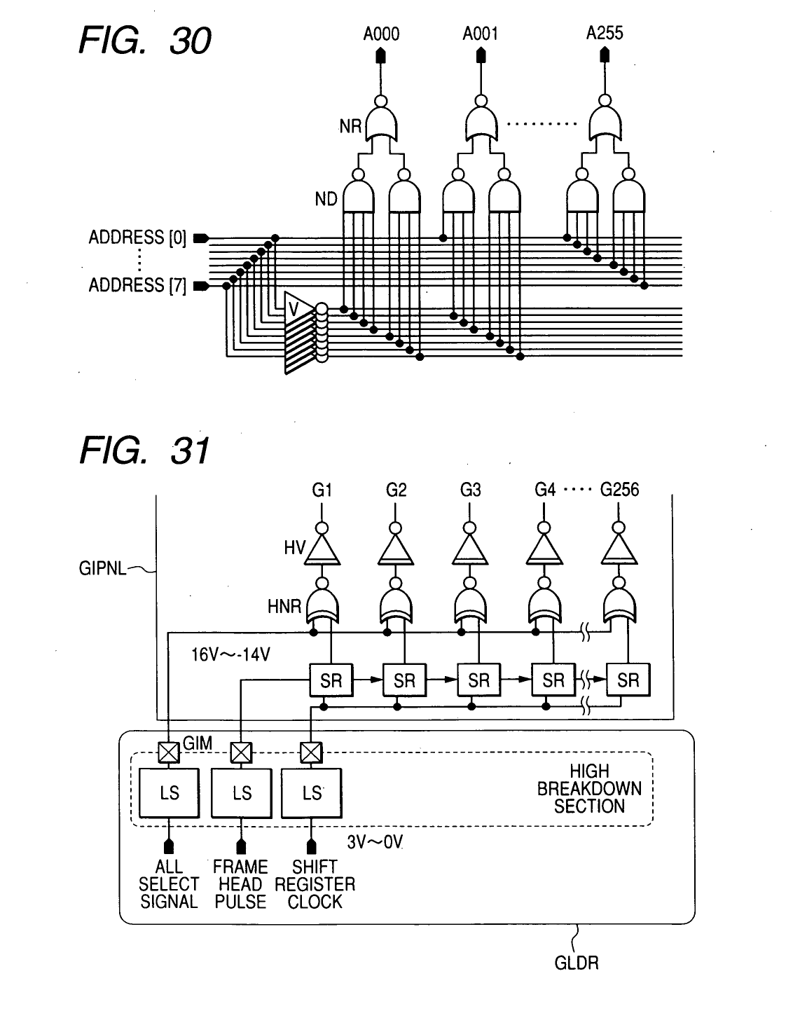

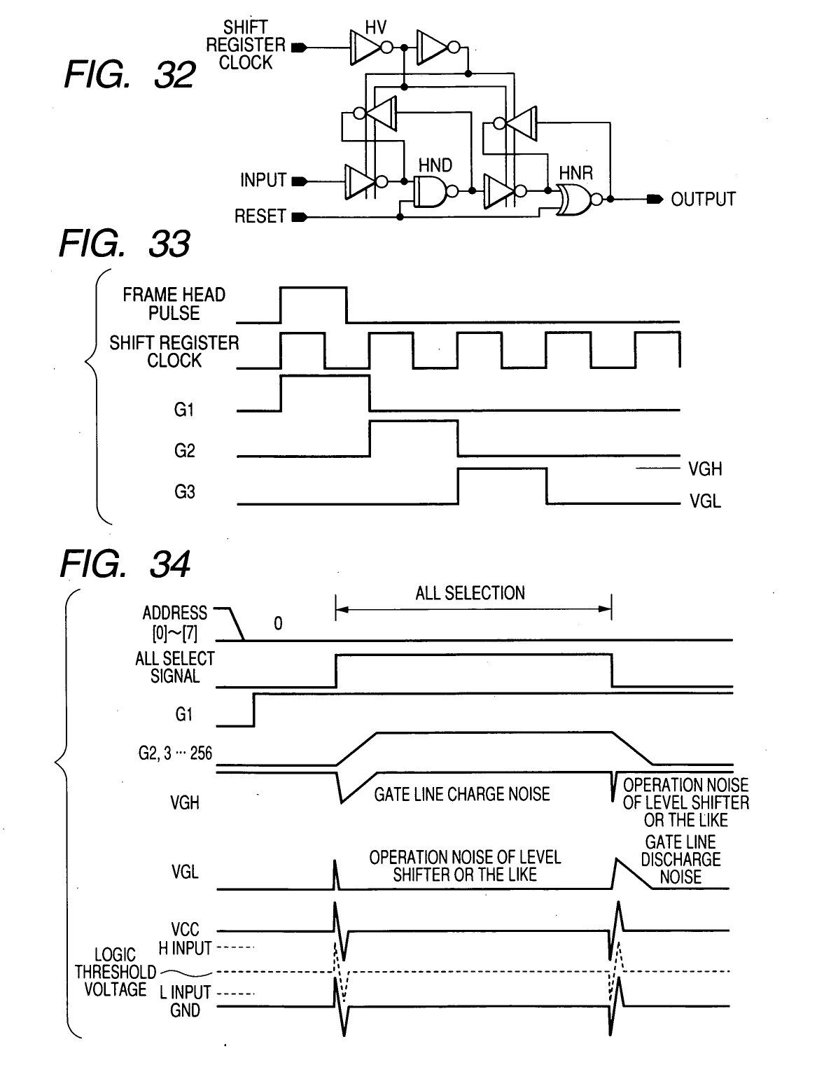

FIGS. 22 through 24 are respectively explanatory diagrams each of which compares the number of decode bits and a mounting area for a semiconductor integrated circuit chip where a semiconductor circuit of a form previously considered by the inventors of the present application, which collectively decodes all bits of address signals, and a two-stage decode system according to the present invention are adopted. FIG. 22 show a case in which inputted address signals are predecoded and latched and they are post-decoded after their level-shifting, FIG. 23 shows a case in which inputted address signals are latched and predecoded and they are post-decoded after their level-shifting, and FIG. 24 shows a case in which inputted address signals are latched and level-shifted, followed by being predecoded, and thereafter they are post-decoded, respectively.

Incidentally, the area of each wiring region and the like are not taken into consideration in FIGS. 22 through 24. The horizontal axes of FIGS. 22 through 24 respectively indicate combinations of division of the number of bits constituting address signals, and the vertical axes thereof respectively indicate areas (relative values) on semiconductor integrated circuit chips. FIG. 22 shows respective areas of a decoder, a latch and a level shifter from above, FIG. 23 shows respective areas of a latch, a decoder, a level shifter and a buffer from above, and FIG. 24 shows respective areas of a latch, a level shifter, a decoder and a buffer from above, respectively.

It is understood even from any of FIGS. 22 through 24 that when bits constituting address signals constituted of 8 bits are divided into 4 bits and 4 bits and they are predecoded and post-decoded, the area may be the least. It is understood that as the absolute value of a difference between constituent bits like 5 bits and 3 bits becomes small as compared with the case in which the combination of the bits constituting the divided, predecoded and post-decoded address signals is represented in the form of 7 bits and 1 bit, the area can be reduced by decreasing the number of level shifters in FIGS. 22 and 23, whereas in FIG. 24, the area can be reduced by decreasing the number of elements constituting a decoder.

In each of the embodiments referred to above, the plural bits of the address signals are decoded (pre-stage decoded/predecoded) once and thereafter decoded again (post-stage decoded/post-decoded) without collectively decoding them at a time. It is thus possible to greatly reduce the number of level shifters. Since some bits of the address signals are decoded and the remaining address signals are decoded, the area of each decoder can be reduced. Dividing the gate drivers into high and low breakdown sections without setting all of them to the high breakdown section enables reduction in power consumption and area.

Such a semiconductor circuit as shown in the first embodiment or the like has such an input node as to be inputted with an all select signal. This is equivalent to one of a type that in such a semiconductor circuit as to drive a liquid crystal display device or unit, electrical charges that remain in pixels of the liquid crystal display unit are extracted upon activation or deactivation of a power supply of the liquid crystal display unit to reset it, thus preventing burning of the screen of the liquid crystal display unit and preventing polarization of a liquid crystal in the liquid crystal display unit to thereby prolong the life span of the liquid crystal display unit.

For the purpose of the reset operation of the liquid crystal display unit, there is known a system for inputting an all select signal and a system for inputting addresses to decoders and thereby driving each single gate line driver. In the system for inputting the all select signal, noise occurs in a power supply or the like because gate line drivers, level shifters and the like are operated all at once. Since, however, they can be operated when the all select signal is inputted only once, a microprocessor for controlling a liquid-crystal driving semiconductor circuit is low in burden and its reset operation is also fast. Particularly when the reset operation is performed upon start-up of a liquid crystal display unit applied to a cellular phone or the like, there might be a need to perform the reset operation of the liquid crystal display unit upon power-up of the cellular phone and upon its transition from a standby state to an active state. In such a case, the microprocessor needs to set an initial value to each of various devices (an RF module, a power supply circuit, a memory, a semiconductor circuit for driving the liquid crystal display unit, etc.). Hence a heavy operational burden is placed on the microprocessor. Therefore, the system for performing the input of the all select signal which is done in one operation, is low in burden for the microprocessor.

On the other hand, the system for inputting the addresses to the decoders and thereby driving each single gate line driver can solve the problem that noise occurs in the power supply or the like. However, time is taken for the reset operation and the time for switching between the display and non-display of the liquid crystal display unit is taken. Incidentally, the present inventors have thought that such a circuit that when a semiconductor circuit receives a signal for indicating a reset operation from the microprocessor, it automatically counts addresses to perform the reset operation, is provided to lighten the operational burden of the microprocessor. Since, however, the time is taken for the reset operation, the microprocessor needs a timer operation for waiting out the reset operation and hence the operational burden on the microprocessor is still large.

Operation waveforms shown in FIG. 34 are diagrams for describing the system for inputting the all select signal to perform resetting in the semiconductor circuit of the first embodiment shown in FIG. 1. The address signals AD[0] through AD[7] are first assumed to be all 0. In doing so, only the gate line terminal GTM connected to the gate line G1 goes High so that a signal is outputted. Thereafter, when the all select signal is taken High, the address signals are placed in an all selection period so that the gate lines G2, G3 . . . G256 rise at a stroke. The reason why the operation waveforms shown in FIG. 34 do not rise at a stroke at this time, is that since various loads are placed on the gate lines upon driving them, time is taken to make a Low to High transition. Although the time taken to make the Low to High transition depends upon each product, the time ranges from a few 100 ns to a few μs.

Incidentally, a time interval for gate line charge noise of VGH corresponding to a power supply of the high breakdown section, and a time interval for gate line discharge noise of VGL corresponding to another power supply of the high breakdown section are similar during the time taken to make the gate lines G2, G3 . . . G256 from High to Low. When the gate lines G2, G3 . . . G256 rise at a stroke and fall, operation noise of each level shifter or the like is carried on VGH corresponding to the power supply of the high breakdown section and VGL corresponding to another power supply of the high breakdown section. This time is a few ns since it is directed toward only the internal circuit operation of the semiconductor circuit. In the case of the semiconductor circuit having such a configuration as shown in FIG. 25 in particular, the area of the high breakdown section is large because the area of each level shifter LS or the like is large. Therefore, the load placed upon driving is also large and operation noise of the level shifter or the like is large. As a result of these noise being carried on the power supplies, noise is carried even on VCC and GND corresponding to power supplies of each internal circuit in the semiconductor circuit, such as a low breakdown section.

VCC and GND corresponding to the power supplies of each internal circuit in the semiconductor circuit, and the logical threshold value of the internal circuit vary in accordance with the internal noise in the semiconductor circuit as shown in FIG. 34. Therefore, the probability that noise will cause a malfunction, is not high where the transfer of signals is performed only inside the semiconductor circuit. However, this is of such one as represented in the form of a High input and a Low input (corresponding to the input/output or the like of a parallel bus signal and an RGB signal indicative of signals inputted/outputted to and from the system interface SVS-IF and the external display interface RGB-IF in the configuration shown in FIG. 20). Since the High input and the Low input corresponding to the signals for performing the transfer of signals between the semiconductor circuit and the outside do not vary according to noise, the logical threshold value of each internal circuit in the semiconductor circuit might crosses the High input and the Low input due to the noise. This will cause a malfunction. Thereafter, the gate lines G2, G3 . . . G256 fall at a stroke even when the all select signal is taken low, so that noise is carried on VGH and VGL corresponding to the power supplies in the high breakdown section. As a result, noise is carried even on VCC and GND corresponding to the power supplies of the internal circuit in the semiconductor circuit, such as the low breakdown section. This will cause a malfunction of the semiconductor circuit.

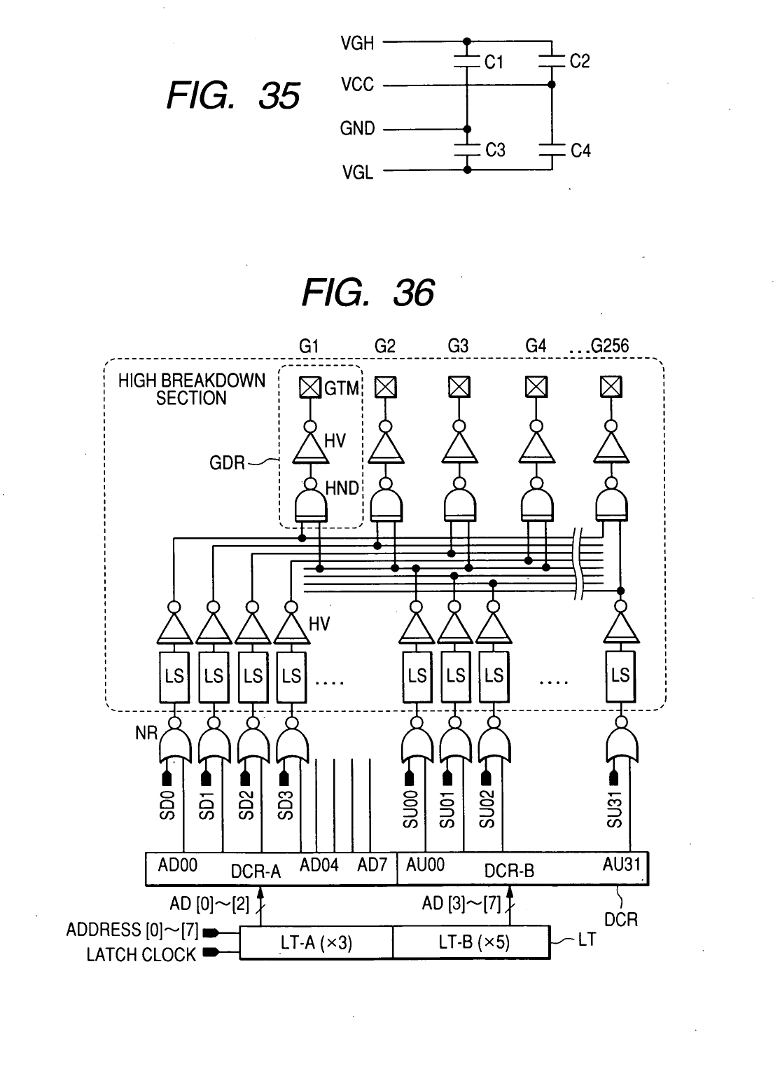

FIG. 35 is a diagram for indicating how noise is transferred in the semiconductor circuit of the first embodiment shown in FIG. 1. Various parasitic capacitances are provided between VCC and GND corresponding to the power supplies of the internal circuit in the semiconductor circuit and between VGH and VGL corresponding to the power supplies of the high breakdown section, respectively, as indicated by C1 through C4. These are various as in the case of, for example, ones among wells on a semiconductor substrate, the gate of each MOS and metal wirings. Noise jumps from VGH and VGL corresponding to the power supplies of the high breakdown section to VCC and GND corresponding to the power supplies of the internal circuit in the semiconductor circuit through these parasitic capacitances. Thus, the logical threshold value of the internal circuit in the semiconductor circuit varies so that the High input and the Low input are misrecognized, thus causing a malfunction.

### Ninth Preferred Embodiment

As mentioned above, the present inventors have found the problem that when the gate driver sections are all selectively driven, noise is produced in the power supply or the like to destabilize the operation of the semiconductor circuit. The present embodiment is provided to solve it. Its configuration corresponds to one improved in the configuration of FIG. 8 showing the third embodiment. Constituent elements given the same reference numerals are not explained. As the configuration of the present embodiment, there is also known such a configuration as shown in FIG. 20.

FIG. 36 is a configurational diagram of the present embodiment. As compared with FIG. 8, addresses to be decoded by a first decoder DCR-A and a second decoder DCR-B of a predecoder DCR are divided into address signals AD[0] through AD[2] in the first decoder DCR-A and address signals AD[3] through AD[7] in the second decoder DCR-B, whereby other circuit configurations and connections are changed. Further, the present embodiment is configured in such a manner that SD0 through SD3 and SU00 through SU31 are inputted to one input terminals of NOR gates NRs to which the all select signal has been inputted. Although a circuit for controlling a reset operation of a liquid crystal driver is not limited in particular, it is provided in the gate address counter GADC shown in FIG. 20. The circuit for controlling the reset operation is configured so as to operate in response to a command or the like issued from a microprocessor for controlling the semiconductor circuit to control the reset operation.

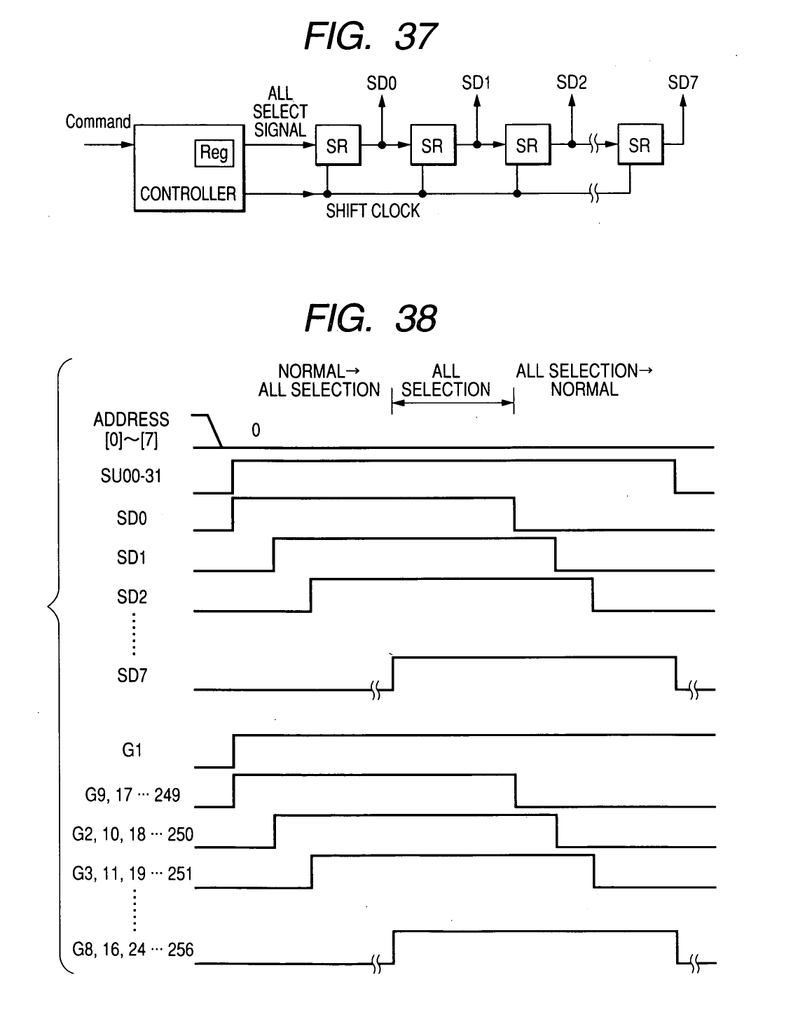

FIG. 37 is a configurational diagram of a circuit for controlling a reset operation of the liquid crystal driver employed in the ninth embodiment. A flag that enables execution of the reset operation is set on a register Reg of a controller in response to a Command issued from outside through a microprocessor or the like. Thus, an all select signal and a shift clock for performing the reset operation are outputted from the controller, and the all select signal is latched in SR latches in a predetermined cycle. In doing so, SD0 through SD7 are outputted every predetermined cycles.

FIG. 38 is a diagram for describing the operation of the semiconductor circuit illustrated in the ninth embodiment. In the present embodiment, the semiconductor circuit for driving the liquid crystal display unit is one of such a type that all selection driving for the reset operation of the liquid crystal display unit is improved and divided into several groups, and in this condition, plural gate lines are selected and driven to thereby make speeding up of the reset operation and a reduction in noise compatible with each other. The present embodiment is configured in such a manner that all select signals are inputted in parts and the gate lines are selected by 32 and driven to perform the reset operation. Upon the reset operation, address signals AD[0] through AD[3] are first assumed to be all 0. In doing so, only the gate line G1 rises. Next, in order to perform the reset operation, SU00 through SU31 are all taken High and SD0 is also taken High. By doing so, the gate lines G9, G17 . . . G249 go High. Next, SD1 is taken High after the elapse of a predetermined period. By doing so, the gate lines G2, G10 . . . G250 go High. This procedure is repeated below until SD7 is brought to a High level, and all the gate lines G1 through G256 go High during a period represented as all selection in FIG. 38.

Thereafter, SD0 is set low and the gate lines G9, G17 . . . G249 are taken Low. Next, SD1 is set Low after the elapse of a predetermined period. In doing so, the gate lines G2, G10 . . . G250 are taken Low. This procedure is repeated below until SD7 is brought to a Low level. Further, SU00 through SU31 are thereafter taken Low and the reset operation is completed. These reset operations are controlled by the circuit for controlling the reset operation. Thus, there is no need to input the signals for driving the gate lines from outside through the microprocessor one by one, and hence an operational burden on the microprocessor can be reduced. With the execution of the reset operation in parts every several groups, the time necessary for the reset operation is shortened. It is thus possible to reduce the time required to perform switching between the display and non-display of the liquid crystal display unit. With the shortening of the time for the reset operation, the time for the timer operation referred to above can be reduced. Therefore, the operational burden on the microprocessor for controlling the semiconductor circuit can be lightened as compared with the system for driving the gate lines one by one.

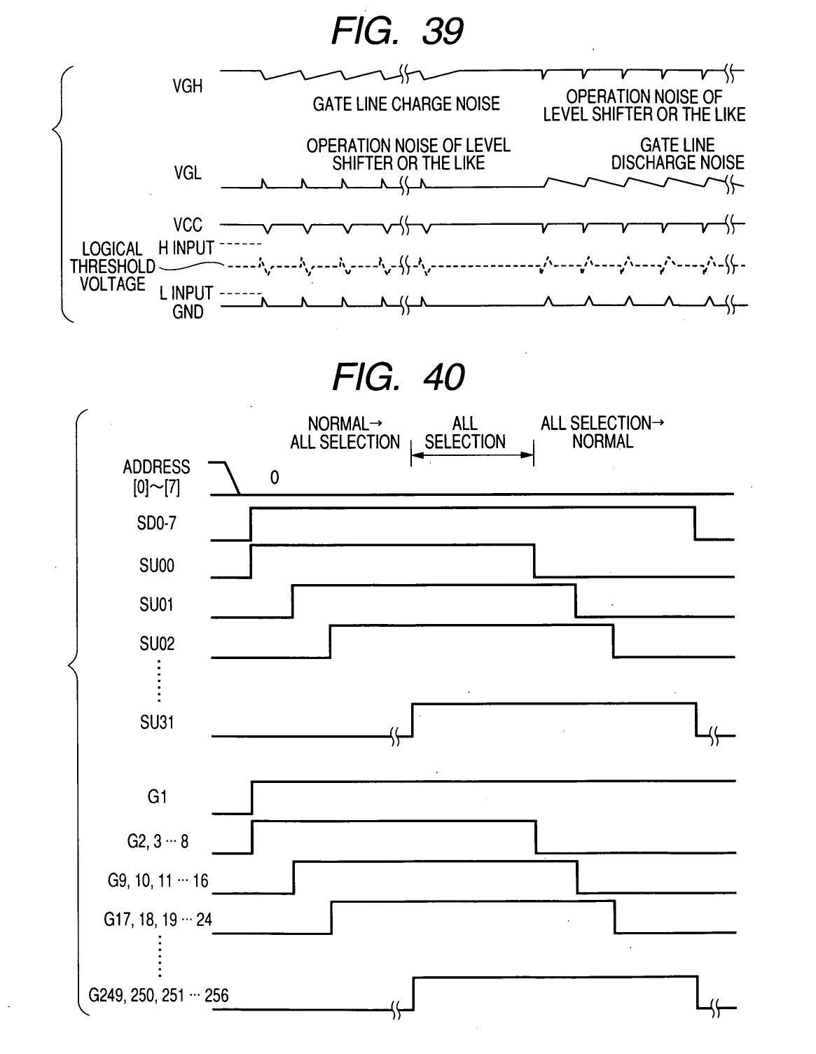

FIG. 39 is a diagram showing power noise of the semiconductor circuit of the present embodiment. Although the number of times in which gate line charge noise, gate line discharge noise and operation noise of each level shifter or the like occur increases upon execution of a reset operation once as is understood by comparison with FIG. 34, their magnitudes are reduced. It is therefore possible to prevent a malfunction of the semiconductor circuit. As is understood by looking at FIG. 39, it is possible to avoid that the logical threshold value of the internal circuit in the semiconductor circuit crosses the High input and the Low input due to the noise as shown in FIG. 34. Thus, the reliability of the semiconductor circuit is enhanced.

### Tenth Preferred Embodiment

FIG. 40 is a diagram for describing an example of the operation of the semiconductor circuit illustrated in the tenth embodiment. Its configuration is identical to FIG. 36 although no particular restriction is imposed on the configuration. In the present embodiment, the address signals AD[0] through AD[7] are first assumed to be all 0 upon a reset operation. In doing so, only the gate line G1 rises. Next, SD0 through SD7 are all taken High and SU00 is also taken High to perform the reset operation. By doing so, the gate lines G2, G3 . . . G8 go High. Next, SU01 is set High after the elapse of a predetermined period. By doing so, the gate lines G9, G10 . . . G16 go High. This procedure is repeated subsequently until SU31 reaches a High level. All the gate lines G1 through G256 are taken High during a period taken as all selection in FIG. 40.

Thereafter, SU00 is set low and the gate lines G2, G3 . . . G8 are taken Low. Next, SU01 is set Low after the elapse of a predetermined period. In doing so, the gate lines G9, G10 . . . G16 are taken Low. This procedure is repeated below until SU31 is brought to a Low level. Further, SD0 through SD7 are thereafter taken Low and the reset operation is completed. Reducing the number of the simultaneously-driven gate lines by 8 as in the present embodiment as compared with the 32 lines in FIG. 38 enables a further reduction in noise. In the circuit for controlling the reset operation of the liquid crystal driver in the present embodiment, the signals to be outputted are changed from SD0 through SD7 to SU00 through SU31 and the number of SR latches and the like are changed in addition to it, as compared with FIG. 37.

What is claimed is:

1. A semiconductor circuit for supplying gate signals to gate terminals, respectively, of a display panel in which a number of pixels constituted of active elements having the gate terminals are arranged in matrix form, comprising:
a pre-stage decoder comprising a pre-stage first decoder which decodes a bit of part of address signals for selecting the gate terminals, and a pre-stage second decoder which decodes the remaining address signals; and
post-stage decoders which decode decode outputs of the respective decoders in the pre-stage decoder.

2. The semiconductor circuit according to claim 1, further including:
latches which respectively latch the respective decode outputs of the pre-stage first decoder and the pre-stage second decoder; and
level shifters which respectively shift absolute values of respective voltage levels of the decode outputs of the pre-stage first decoder and the pre-stage second decoder to a high breakdown side, the respective decode outputs of the pre-stage first decoder and the pre-stage second decoder being latched in the latches,
wherein outputs of the level shifters are inputted to the post-stage decoders respectively.

3. The semiconductor circuit according to claim 2,
wherein the address signals are constituted of 8 bits, and part of the address signals is represented in a 1 bit and the remaining address signals are represented in 7 bits, and
wherein the pre-stage first decoder decodes a most significant bit or a least significant bit.

4. The semiconductor circuit according to claim 2, wherein the number of the level shifters which respectively shift the absolute values of the voltage levels of the output signals based on the address signals to a high breakdown side, is smaller than the number of gate line terminals for outputting the gate signals.

5. The semiconductor circuit according to claim 1, further including:
latches each comprising a first latch which latches a bit of part of the address signals for selecting the gate terminals and a second latch which latches the remaining bits; and
level shifters which respectively shift the absolute values of respective voltage levels of outputs of the pre-stage first decoder and the pre-stage second decoder to the high breakdown side,
wherein the bit of the part latched in the first latch is outputted to the pre-stage first decoder, and the remaining bits latched in the second latch are outputted to the pre-stage second decoder, and
wherein the output of the pre-stage first decoder and the output of the pre-stage second decoder both passed through the level shifters are outputted to the post-stage decoders respectively.

6. The semiconductor circuit according to claim 5,
wherein the address signals are constituted of 8 bits, and part of the address signals is represented in a 1 bit and the remaining address signals are represented in 7 bits, and
wherein the pre-stage first decoder decodes a least significant bit.

7. The semiconductor circuit according to claim 5, wherein a high breakdown voltage of each of the post-stage decoders is set higher than that of each of the latches for latching the signals based on the address signals.

8. The semiconductor circuit according to claim 5, further including:
latches each comprising a first latch which latches a bit of part of the address signals for selecting the gate terminals and a second latch which latches the remaining bits; and
level shifters which respectively shift the absolute values of respective voltage levels of the bit of the part and the remaining bits both latched in the first latch and the second latch to a high breakdown side,
wherein the output of the first latch passed through a corresponding level shifter is inputted to the pre-stage first decoder, and
wherein the output of the second latch passed through a corresponding level shifter is inputted to the pre-stage second decoder.

9. The semiconductor circuit according to claim 8, wherein the address signals are constituted of 8 bits, and part of the address signals is represented in a 1 bit and the remaining address signals are represented in 7 bits.

10. the semiconductor circuit according to claim 8, wherein the address signals are constituted of 8 bits, and part of the address signals is represented in 4 bits and the remaining address signals are represented in 4 bits.

11. The semiconductor circuit according to claim 1, wherein the post-stage decoders are buffer decoders which share buffers.

12. The semiconductor circuit according to claim 11, wherein the address signals are constituted of 8 bits, and part of the address signals is represented in a 1 bit and the remaining address signals are represented in 7 bits.

13. A semiconductor circuit for supplying gate signals to gate terminals, respectively, of a display panel in which a number of pixels constituted of active elements having the gate terminals are arranged in matrix form,
wherein waveforms outputted to the gate terminals change between a first reference voltage and a second reference voltage lower in level than the first reference voltage and have inflexion points between the first reference voltage and the second reference voltage upon said change.

14. The semiconductor circuit according to claim 1, further comprising a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

15. A semiconductor circuit for supplying gate signals to gate terminals, respectively, of a display panel in which a plurality of pixels having the gate terminals are arranged in matrix form, comprising:
a pre-stage logic circuit including a pre-stage first logic gate which receives bit signals corresponding to part of address signals for selecting the gate terminals, and a pre-stage second logic gate which receives the remaining address signals;
post-stage logic gates each of which receives outputs of the first and second logic gates;
latches for latching signals based on the address signals respectively; and
level shifters which respectively shift absolute values of voltage levels of signals outputted from the latches to a high breakdown side,
wherein breakdown voltages of the post-stage logic gates are set higher than those of the latches, and the number of the level shifters is smaller than the number of gate line terminals for outputting the gate signals respectively.

16. The semiconductor circuit according to claim 15, further including:
the latches which respectively latch the respective outputs of the pre-stage first logic gate and the pre-stage second logic gate; and
the level shifters which respectively shift the absolute values of respective voltage levels of decode outputs of the pre-stage first logic gate and the pre-stage second logic gate to the high breakdown side, the respective decode outputs of the pre-stage first logic gate and the pre-stage second logic gate being latched in the latches,
wherein outputs of the level shifters are inputted to the post-stage logic gates respectively.

17. The semiconductor circuit according to claim 15, further including:
the latches each comprising a first latch which latches a bit of part of the address signals for selecting the gate terminals respectively, and a second latch which latches the remaining bits; and
the level shifters which respectively shift the absolute values of respective voltage levels of the outputs of the pre-stage first logic gate and the pre-stage second logic gate to the high breakdown side,
wherein the bit of the part latched in the first latch is outputted to the pre-stage first logic gate, and the remaining bits latched in the second latch are outputted to the pre-stage second logic gate, and
wherein an output of the pre-stage first logic gate and an output of the pre-stage second logic gate both passed through the level shifters are outputted to the post-stage decoders respectively.

18. The semiconductor circuit according to claim 15, further including:
the latches each comprising a first latch which latches a bit of part of the address signals for selecting the gate terminals respectively, and a second latch which latches the remaining bits; and
the level shifters which respectively shift the absolute values of respective voltage levels of the bit of the part and the remaining bits both latched in the first latch and the second latch, to the high breakdown side,
wherein an output of the first latch passed through a corresponding level shifter is inputted to the pre-stage first logic gate, and an output of the second latch passed through a corresponding level shifter is inputted to the pre-stage second logic gate.

19. The semiconductor circuit according to claim 15, wherein the post-stage logic gates are buffer logic gates which share buffers.

20. The semiconductor circuit according to claim 16, wherein the level shifters are classified into:
first level shifters each of which shifts a voltage level of a decode output of the pre-stage first logic gate to the high breakdown side, the decode output of the pre-stage first logic gate being latched in a corresponding latch, and
second level shifters each of which shifts a voltage level of a decode output of the pre-stage second logic gate to the high breakdown side, the decode output of the pre-stage second logic gate being latched in a corresponding latch, and
wherein the number of the first level shifters and the number of the second level shifters are the same.

21. A semiconductor circuit for supplying gate signals to gate terminals, respectively, of a display panel in which a plurality of pixels having the gate terminals are arranged in matrix form, comprising:
a pre-stage decoder which performs decoding in response to bit signals of address signals which select the gate terminals respectively;
post-stage decoders each of which performs decoding in response to an output of the corresponding pre-stage decoder;
latches for latching signals based on the address signals therein; and
level shifters which respectively shift an absolute values of voltage levels of signals outputted from the latches,
wherein breakdown voltages of the post-stage decoders are set higher than those of the latches, and the number of the level shifters is smaller than the number of gate line terminals for outputting the gate signals respectively.

22. The semiconductor circuit according to claim 21, further including:
latches which respectively latch decode outputs of the pre-stage decoder; and
level shifters which respectively shift the absolute values of voltage levels of the decode outputs of the pre-stage decoder, which are latched in the latches, to the high breakdown side,
wherein the outputs of the level shifters are inputted to the post-stage decoders respectively.

23. The semiconductor circuit according to claim 21, wherein the number of the level shifters which respectively shift the absolute values of a voltage levels of an output signals based on the address signals to the high breakdown side, is smaller than the number of gate line terminals for outputting the gate signals.

24. The semiconductor circuit according to claim 21, further including:
latches which respectively latch bits of address signals for selecting the gate terminals; and
level shifters which respectively shift the absolute values of voltage levels of an outputs of the pre-stage decoder to the high breakdown side,
wherein bits of the address signals latched in the latches are outputted to the pre-stage decoder, and
wherein outputs of the pre-stage decoder passed through the level shifters are outputted to the post-stage decoders respectively.

25. The semiconductor circuit according to claim 21, wherein breakdown voltages of the post-stage decoders are set higher than those of the latches for latching signals based on the address signals.

26. The semiconductor circuit according to claim 21, further including:
the latches which respectively latch bits of the address signals for selecting the gate terminals respectively; and
the level shifters which respectively shift the absolute values of voltage levels of the bits of the address signals latched in the latches to the high breakdown side,
wherein outputs of the latches passed through the level shifters are inputted to the pre-stage decoder.

27. The semiconductor circuit according to claim 21, wherein the post-stage decoders are buffer decoders which share buffers respectively.

28. The semiconductor circuit according to claim 21, further comprising a system interface circuit inputted with a parallel signal from an external signal source, an external display interface circuit inputted with RGB display data therein, a timing generator, gradation voltage generators, a graphic RAM, a source driver, and a gate driver which supplies gate signals to the gate terminals.

29. A semiconductor circuit for supplying gate signals to a plurality of gate terminals, respectively, of a display panel in which a number of pixels are arranged in matrix form, comprising:
a plurality of first gate terminals; and
a plurality of gate drivers connected to the first gate terminals respectively,
wherein when gate lines of the display panel connected to the semiconductor circuit are reset, the plurality of first gate terminals are divided into several groups, and the plurality of first gate terminals constituting the respective groups are driven simultaneously and the groups are driven at different times.

30. A semiconductor circuit for supplying gate signals to a plurality of gate terminals, respectively, of a display panel in which a number of pixels are arranged in matrix form, comprising:
a plurality of first gate terminals;
a plurality of second gate terminals; and
a plurality of gate drivers connected to the first gate terminals or the second gate terminals,
wherein when gate lines of the display panel connected to the semiconductor circuit are reset, the plurality of first gate terminals and the plurality of second gate terminals are driven at different times.

31. The semiconductor circuit according to claim 29, further including a circuit for controlling a reset operations,
wherein the circuit is operated in response to a command issued from a microprocessor capable of controlling the semiconductor circuit.

32. The semiconductor circuit according to claim 30, further including a circuit for controlling the reset operations,
wherein the circuit is operated in response to a command issued from a microprocessor capable of controlling the semiconductor circuit.

33. The semiconductor circuit according to claim 31, further including:
a pre-stage decoder comprising a pre-stage first decoder which decodes a bit of part of address signals for selecting the first gate terminals, and a pre-stage second decoder which decodes the remaining address signals; and
post-stage decoders which respectively decode decode outputs of the respective decoders of the pre-stage decoders.

34. The semiconductor circuit according to claim 31, further including:
a pre-stage decoder which performs decoding in response to bit signals of address signals for selecting the first gate terminals;
post-stage decoders which perform decoding in response to an outputs of the pre-stage decoder;
level shifters which respectively shift an absolute values of voltage levels to a high breakdown side and supply the shifted signals to the post-stage decoders; and
a control circuit for controlling an operation of the semiconductor circuit,
wherein a breakdown voltage of each of transistors constituting the post-stage decoders is set higher than that of each of transistors constituting the control circuit, and the number of the level shifters is smaller than the number of the first gate terminals.
